(19) United States
(12) Patent Application Publication
(10) Pub. No.: US 2025/0336561 A1
(43) Pub. Date: Oct. 30, 2025

(54) ISOTOPE SEPARATION SYSTEM WITH VELOCITY FILTER

(71) Applicant: Nusano, Inc., Valencia, CA (US)

(72) Inventors: Glenn B. Rosenthal, Los Angeles, VA (US); Christopher A. Bailey, Lindon, UT (US); Richard W. Sisson, Hollday, UT (US); Charles Cumberland MCGUIRE, Salt Lake City, UT (US); Melissa M. Daniels, Eagle Mountain, UT (US); Steven R. Burnham, Herriman, UT (US)

(21) Appl. No.: 19/192,062

(22) Filed: Apr. 28, 2025

Related U.S. Application Data
(60) Provisional application No. 63/640,156, filed on Apr. 29, 2024.

(51) Int. Cl. G21G 1/10; G21G 1/00

(52) U.S. Cl. CPC G21G 1/10; G21G 2001/0094

(57) ABSTRACT

Various embodiments include a system for isotope separation. The system may include an ion source assembly configured to generate ions from a source material, an injector assembly positioned to receive, accelerate, and focus the ions into a beam, and a separator assembly positioned to receive ions from the injector assembly. The separator assembly may include a velocity filter with a magnet assembly and two electrodes with curved portions angled to vary the electric field to compensate for non-linearities in the magnetic field. The system may also include a collimator coupled to a distal end of a drift path portion, the collimator comprising a first slit aperture. An isotope collector module comprising a first removable collection surface may be positioned beyond the collimator to receive the first target isotope ions.

### CROSS-REFERENCE TO RELATED APPLICATIONS

This application claims the benefit of priority to U.S. Provisional Application No. 63/640,156 titled “Systems and Methods for Lu-177 Isotopic Production and Separation,” filed Apr. 29, 2024, which is hereby incorporated by reference in its entirety for all purposes.

### BACKGROUND

Owing to its favorable decay characteristics, Lu-177 is an attractive radionuclide for a variety of medical diagnostic and therapeutic applications. Lu-177 can be produced by two different neutron routes, the direct route [Lu¹⁷⁶(n⁰,γ)Lu¹⁷⁷] using natural or enriched Lu-176, and the indirect route [Yb¹⁷⁶(n⁰,γ)Yb¹⁷⁷→Lu¹⁷⁷+β⁻] using highly enriched Yb-176.

Each route produces a product of distinctly different specific activity and radionuclide composition. Of these two options, the indirect route has seen significant modern industrial investment due to the inherent capability of producing a high specific activity non-carrier added product when using highly enriched Yb-176 and coupled with an appropriate radiochemical separation process. Paradoxically, these two features of the indirect route (use of highly enriched Yb-176 and radiochemical separation) are the primary impediments to wide-scale high volume production using this method. In the first case, obtaining highly enriched Yb-176 is difficult due to its limited manufacture and availability, which has only been complicated by the increasing market demand for Lu-177. Further, due to the nuclear properties of Yb-168 and Yb-174, the isotopic purity of the starting material must be very high for an enriched stable isotope and is generally required to be greater than 99.7% Yb-176 to prevent the production of radio and chemical interferents in the final product. These concerns further complicate the manufacture, handling, and reclamation of highly enriched Yb-176 and significantly increase its associated costs. In the second case, the chemical properties of lutetium and ytterbium are different enough to make chemical separation possible using a few potential proprietary processes, but similar enough to make chemical separation very difficult as production scale increases. The final point to be made regarding the indirect route is that the meager neutron capture cross-section (2.6 b) of Yb-176 limits the ability of this process to produce industrially useful quantities of Lu-177 without access to high flux nuclear research reactors and large mass inventories of the difficult to obtain highly enriched Yb-176 as well as significant capital investment for multiple parallel radiochemical processing and Yb-176 reclamation trains.

In opposition to the indirect route, the production of Lu-177 by the direct [Lu¹⁷⁶(n⁰,γ)Lu¹⁷⁷] reaction pathway by thermal neutron capture has a very high production yield characterized by the large neutron capture cross-section of Lu-176 (2020 b), allowing the process to produce large quantities without the need for access to high flux nuclear research reactors or highly enriched starting material (and will in fact out-perform the indirect method using only natural, unenriched lutetium (2.6% Lu-176). Further, the direct route can be easily scaled to high volume manufacturing without concern for radio or chemical interferents, or the need for proprietary radiochemical separation processes or equipment. The only tangible drawback of the direct route is the limited technology available to isotopically purify the final product in order to produce a high-specific activity non-carrier added product.

Isotope separation is a field of technology that involves isolating specific isotopes of elements from mixtures containing multiple isotopes. This process has applications in various industries, including nuclear energy, medical diagnostics and treatments, and scientific research. Isotope separation techniques typically exploit small differences in the physical or chemical properties of isotopes to achieve separation.

Several methods have been developed for isotope separation, including gaseous diffusion, centrifugation, electromagnetic separation, and laser isotope separation. These techniques vary in their efficiency, scalability, and suitability for different elements and applications. Advances in areas such as ion optics, high-vacuum systems, and precision control of electromagnetic fields have enabled improvements in the design and performance of isotope separation systems over time.

### SUMMARY

Various embodiments include equipment, methods, and techniques necessary to produce a high-specific activity of a radionuclide, such as but not limited to Lu-177, for use in nuclear medicine products. Some embodiments may utilize the direct [Lu¹⁷⁶(n⁰,γ)Lu¹⁷⁷] reaction pathway, thereby overcoming supply and yield issues commonly encountered with the indirect [Yb¹⁷⁶(n⁰,γ)Yb¹⁷⁷→Lu¹⁷⁷+β⁻] route to produce high-specific activity, non-carrier added Lu-177. To support the production of radiopharmaceutical quantities of Lu-177 using the direct reaction, various embodiments provide systems, equipment, and methods for separating Lu-177 from the Lu-176 target material to produce kilocurie quantities of high-specific activity Lu-177.

### BRIEF DESCRIPTION OF THE DRAWINGS

The accompanying drawings, which are incorporated herein and constitute part of this specification, illustrate exemplary embodiments of the claims, and, together with the general description given and the detailed description, serve to explain the features herein.

FIG. 1A is a block diagram of an isotope separation system according to various embodiments.

FIG. 1B is a side and top view of a prototype isotope separation system according to various embodiments.

FIG. 2 is a block diagram of an isotope separation system according to some embodiments.

FIG. 3 is a block diagram of an isotope separation system according to some embodiments.

FIG. 4 is a block diagram of an isotope separation system according to some embodiments.

FIG. 5 is a section view of an ion source portion of an isotope separation system according to some embodiments.

FIG. 6 is a section view of an accelerator and Einzel lens assembly portion of an isotope separation system according to various embodiments.

FIG. 7A is a section view of a separator assembly portion of an isotope separation system according to various embodiments.

FIG. 7B is a particle trajectory diagram of a velocity filter assembly according to various embodiments.

FIG. 7C is a particle trajectory diagram of a velocity filter according to various embodiments.

FIG. 7D is an isometric view of a portion of a velocity filter according to some embodiments.

FIG. 7E is an end view of a velocity filter according to some embodiments.

FIG. 7F is a perspective section view of a velocity filter according to some embodiments.

FIG. 7G is an orthogonal view of electrodes from a velocity filter according to some embodiments.

FIG. 8A is a section view of an isotope collector assembly and removal cask according to some embodiments.

FIG. 8B is a block diagram of a two-isotope collector assembly according to some embodiments.

FIG. 8C is a notional diagram of beam deflection elements of a deflector plate of a two-isotope collector assembly according to some embodiments.

FIG. 9 is a block diagram of an ion reflector-suppressor assembly that may be used in some embodiments.

FIG. 10 is an image of an example of pyrolytic graphite that has been exposed to an ion beam and collected a target isotope.

FIG. 11 is a block diagram of a vacuum and gas system for an isotope separation system according to some embodiments.

FIG. 12 is a block diagram of a cooling water system according to some embodiments.

FIG. 13 is a block diagram of an electrical power distribution system according to some embodiments.

FIG. 14 is a block diagram of an instrumentation and control system according to some embodiments.

FIG. 15 is a block diagram of an instrumentation and control system according to various embodiments.

FIG. 16 is a process flow diagram of a method for isotope separation according to various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments provide systems and methods for isotope separation using a velocity filter for use in radioisotope production. Various embodiments include an isotope separation system comprising an ion source assembly, an injector assembly, a separator assembly with a velocity filter, a drift path, a collimator, and an isotope collector module. The velocity filter incorporates electrodes with curved portions to maintain a constant ratio of electric to magnetic field strengths, enabling precise separation of target isotopes and enhanced mass resolution by the system.

The isotope separation system can be configured to isolate specific radioisotopes, such as Lu-177, with high efficiency and purity. The modular design allows for the collection of separated isotopes without disrupting the vacuum environment of the main system, enabling continuous operation and improved productivity.

Various embodiments provide improvements to radioisotope production technologies by enabling high-resolution separation of isotopes with similar masses, increasing the specific activity of the collected product, and allowing for controlled collection rates to meet precise production requirements.

While chemical elements can be purified through chemical processes, isotopes of the same element have nearly identical chemical properties, making chemical separation impractical for all elements except hydrogen. The first technology able to separate, isolate, and/or concentrate isotopes was originally conceived at the University of California, Berkeley by Ernest O. Lawrence. At Oak Ridge National Laboratory, under the auspices of the Manhattan project, the first electromagnetic isotope separators based on his concept were developed to produce the majority of the highly enriched uranium used in the first atomic bombs. These isotope separation devices were called calutrons and operated continuously between 1940 and 1945 to produce highly enriched uranium, before being transitioned to produce other enriched stable isotopes for research purposes. Multiple versions of the calutron were designed and operated in the intervening years until finally ceasing operation in 1998. Countries such as Russia and China continue to operate isotope separators based on the Calutron design to produce enriched stable isotopes for almost every industry.

Current isotope separation systems often struggle to achieve high mass resolution and purity when separating isotopes with very similar masses, such as Lu-177 from other lutetium isotopes. Existing electromagnetic separators typically have limited throughput or require large, complex installations that are impractical for many applications. Additionally, conventional systems often lack the ability to precisely control the rate of isotope collection to match specific production requirements. Therefore, there is an unmet need for an isotope separation system that can achieve high mass resolution and purity in a compact design, while allowing for controlled collection rates to produce radioisotopes like Lu-177 with high specific activity for medical and research applications.

Each reactor target may contain no more than 100 mg of high elemental purity lutetium metal, either in natural, low-enriched or highly-enriched abundances of Lu-176. Given the high density of lutetium metal (9.841 g/cm³), 100 mg is roughly equivalent to the size of a single 0.7 mm mechanical pencil lead, irradiation targets are expected to be pre-deposited onto a substrate material. Reactor grade zirconium has been determined as the best option due to its low neutron activation, chemical inertness, high melting point, and low vapor pressures as compared to lutetium.

Multiple concepts for the physical design of the reactor target are possible, such as a disk target or a filament target.

A 25 mm disk target may be a 100 μm-thick zirconium disk, 25 mm in diameter. The disk could be plated by either evaporative or sputter deposition of lutetium to a thickness of 20 μm. The 25 mm disk may emulate a common reactor target shape normally used for the production of molybdenum-99 from high-purity molybdenum-98, in which multiple target disks are stacked up to 50 mm for a single irradiation. This target form may be used with a Nier-Bernas style ion source, in which the disk is inserted into a position where it can act as the anti-cathode and be indirectly heated independently of the cathode.

The filament target may be envisioned as a wound 1 mm wire filament coil, 6 mm OD by 40 mm long, and having a pitch of 5 mm per revolution. The lutetium may be plated by either evaporative or sputter deposition to a thickness of 20 μm and fully covering the coils within 6 mm on either side of the coil center, and separately encapsulated in an 8 mm OD quartz tube for shipping and irradiation. This target form may be used with a Neir-Bernas style ion source, in which the coil is inserted along the central axis of the cylindrical arc chamber and directly heated similarly to a thermionic filament.

Other potential target configurations include a needle, such as a needle of Zr coated with Lu metal by plating, or evaporative or sputter deposition, a hollow needle having an interior volume of lutetium chloride formed by drawing a LuCl₃ solution into the needle followed by desiccation, or a wire mesh of Zr on which Lu metal is plated.

Regardless of configuration, the target will be separately encapsulated and hermetically sealed within an ampoule containing an inert gas atmosphere. The ampoule can be any of the low-activating, high-purity transition metals, including titanium, zirconium, aluminum, or quartz tubing as specifically directed by the requirements of the irradiator. The encapsulation must be leak checked after sealing to ensure a fully hermetic environment prior to being shipped to the irradiator.

Once targets have been prepared and encapsulated, they will be shipped directly to the location of the irradiation services provider where the target and its encapsulation will be removed from packaging and inserted into a nuclear reactor having an average thermal neutron flux no less than 3×10¹³ n/cm²-s for a period of time between 5 and 7 days. Irradiations at conditions less than those specified can be utilized for testing and validation purposes, but will not produce a sufficient activity of Lu-177 feasible for collection in a reasonable amount of time.

Following irradiation, it may be necessary to store targets on-site for short periods to allow the decay of short-lived radioactive by-products, but targets are expected to contain between 2500 to 3200 Ci of Lu-177 by the time they are received for post-irradiation separation and processing. Once the irradiated capsule is returned and prepared for isotopic separation, the target is removed from the encapsulation.

Prioritizing the mass resolution may be an important aspect of the isotope separation system design because that may enable production of a Lu-177 product of such high-specific activity that it exceeds or at a minimum equals the therapeutic performance of Lu-177 products available using other isotope isolation methods.

Determining the design parameters of the separation process begins with determining the effective mass resolution of the system. While the final system design needs to account for multiple coupled physics phenomena to achieve the specified mass resolution, the specific value of the mass resolution required can be determined based solely on an analysis of the estimated composition of the beam at the entrance of the separator assembly. A complicating factor to this analysis specific to this particular application is the changes anticipated in the beam composition over time due to the decay of Lu-177.

The mass resolution of the system is specifically coupled to the achievable specific activity of the final product. For example, for a system isolating Lu-177, a minimum specification for a non-carrier added product may be greater than 3000 GBq per mg. The theoretical maximum specific activity of Lu-177 is 4108 GBq per mg.

The physical separation between the ion beam peaks in the system required to achieve the appropriate mass resolution at the mass resolving aperture is directly coupled to both the beam width at the beam defining aperture, as well as the mass resolution of the system. In fact, the ratio of the beam width to the mass peak separation distance is equal to the ratio of the mass peak width to the mass peak separation, which together are defined by the mass resolution of the separator.

Determination of the required mass resolution can be performed by analysis based solely on the beam composition, such as the ratio of the atom densities for Lu-175, Lu-176, and Lu-177, as well as other element species within this mass range. In theory, the higher the atom ratio of the product species Lu-177 to the total Lu isotope inventory, the lower the mass resolution of the system that is required to achieve the goal for specific activity of the product.

A mass resolution of 500 or greater results in nearly complete separation of the mass species and will allow collection of the Lu-177 product at both high specific activity and the fully rated mass throughput.

The mass throughput is effectively a metric for how long it takes to process a single target and deliver a single product batch to customers. This aspect heavily impacts the volume of production for a single target and a single machine. Optimizing the mass throughput of the system may be necessary for achieving high-volume production but is most likely to be extraneous when considering the capabilities of the direct [Lu¹⁷⁶(n⁰,γ)Lu¹⁷⁷] production pathway, but is still considered a secondary priority as significant importance is assigned within the industry for consistent, on-time delivery of product due to the short effective shelf-life of Lu-177.

From a process perspective, the mass throughput of the system may be defined by how many curies of Lu-177 activity are produced per batch or period (e.g., Ci/h, Ci/d, Ci/batch, etc.). From the system perspective, the mass throughput is more easily defined and measured by the achievable beam current through the separator assembly during operation (e.g., micro-Amperes (μA), milli-Amperes (mA).

Based on experience, a reasonable performance envelope for mass throughput has been determined to be between 100 μA and 1 mA. The lower value was selected to be a reasonably achievable performance value for ion beam devices of a similar size and type as various embodiments, while the upper value was determined by a rough estimation of the theoretical limits for a device of this type.

Analysis of the separation process at both ends of the performance envelope has been performed to develop a foundation for the expected production volume, and has shown that even at the lower performance value of 100 mA, the system will likely have a significant production volume capability as compared to other manufacturing methods for Lu-177.

At the lower performance value of 100 μA it is anticipated that a single 100 mg target will be fully processed within approximately 6 days, which means that only 1 target per week per machine would need to be irradiated and shipped per week, which is a good match when assuming that an irradiation period is anticipated to be between 5 and 7 days. Designing the system to allow multiple batch extractions during target processing, a single target would be capable of producing 1 product batch per day of operation for a total of 6 product batches per target-machine-week. Each of these product batches would be of a total activity between 200 and 350 Ci assuming an initial target activity of 3200 Ci. When compared against DOT shipping limits for Type A containers, anticipated customer use, and purification process design limits this operating approach is an even more convenient match for the overall process and significantly reduces technical risk. Further, a large amount of flexibility exists within the process to overcome activity and process efficiency limitations, even at the lowest performance value, which far exceeds the capabilities of competing processes based on the indirect [Yb¹⁷⁶(n⁰,γ)Yb¹⁷⁷→Lu¹⁷⁷+β⁻] production pathway.

The process efficiency of the system determines how much of the Lu-177 created during the irradiation process is collected and concentrated into high-specific activity, non-carrier-added Lu-177 product. The process efficiency itself is a bulk metric accounting for material losses at multiple points within the system. Based on the physical operations taking place during separation, the process efficiency can be broken down into several component loss mechanisms, each of which can be addressed independently to impact the overall process efficiency.

The utilization efficiency is specific to the vaporization process occurring within the source module and is primarily impacted by the formation of molecular lutetium complexes, the largest example being oxidation of the lutetium metal to form Lu₂O₃. The ion source vaporization process may use lutetium in metal form. Formation of oxides during handling processes will cause those molecules to be un-vaporizable and become sequestered within the ion source for the duration of the process. Other contributors to this loss mechanism include conversion of metal through other chemical reactions, the formation of solid solutions with the target substrate, and even re-deposition of the lutetium vapor outside of the ionization region of the ion source. Loss by these mechanisms may be controlled by ensuring hermetic sealing during encapsulation and handling within inert environments. A utilization efficiency of ˜95% is expected to be achievable based on prior experience.

The ionization efficiency is a measure of the ion source's ability to ionize the lutetium vapor into the +1 charge state. It is anticipated that some minor fraction of lutetium atoms will not be fully ionized before passing through the ionizing region of the ion source, will be neutralized after ionization, and/or will be ionized into higher charge states. This loss mechanism is likely to be the most dominant, and significant design effort may be required to achieve an efficiency of greater than ˜50% without operational experience that includes detailed measurement and design refinement.

The transport efficiency is a metric for ion losses during transport through the machine. The performance of the separator assembly and its achievable mass resolution are sensitive to the beam emittance during transport, which itself is sensitive to the mass throughput of the system.

The collection efficiency is related to the behavior of the collection module of the system. During the collection process, some ions of lutetium will be effectively lost due to several mechanisms, including re-emission and implantation, as well as the effectiveness of the chemical purification process to extract the deposited lutetium from the collection surface.

As a radioisotope, the Lu-177 will be decaying continuously once removed from the reactor, which is characterized by its half-life of 6.6443 days. In other words, 6.6443 days after the target has been removed from the reactor, it will contain only half of its original activity. This will cause the ratio of Lu-177 to Hf-177 (its decay product) to be constantly decreasing. Mitigating this loss mechanism is only possible by increasing the mass throughput of the system, which, for reasons stated previously, impacts other aspects of the overall process effectiveness. Nevertheless, the volume capability of the direct [Lu¹⁷⁶(n⁰,γ)Lu⁷⁷] production route allows for significant capacity assuming the overall processing period is less than one full half-life of Lu-177.

A post-separation radio-chemical purification and polishing process may be used to ensure that the radiochemical solutions extracted from the product and raffinate collectors meet the requirements of the downstream processes for both final product specification and reclaimed enriched target material.

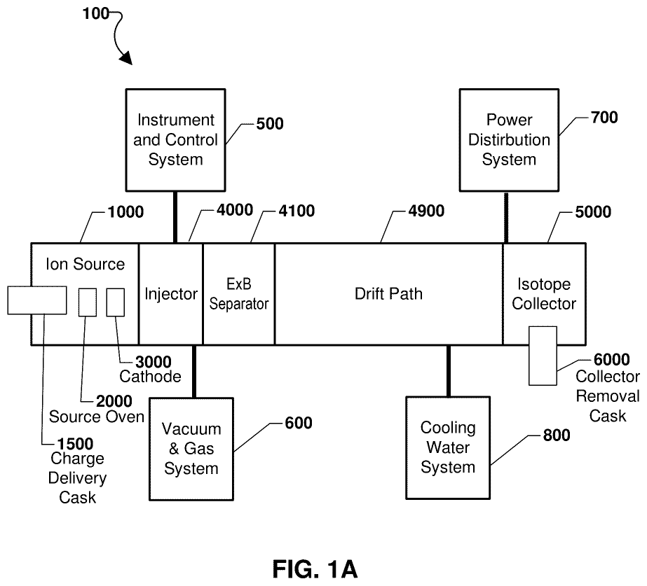

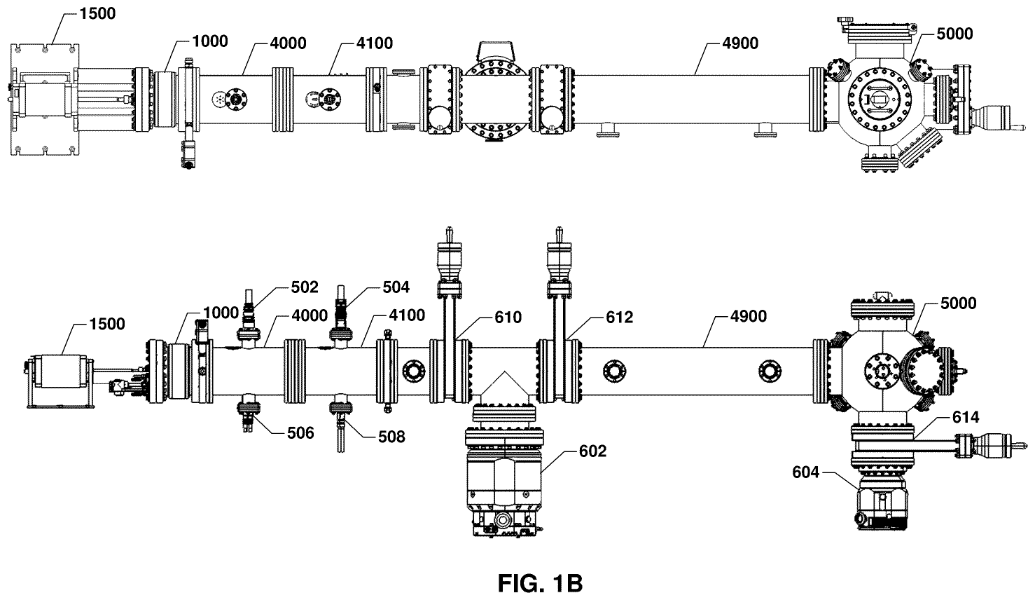

FIG. 1A illustrates major components of an isotope separation system 100 according to various embodiments. The main isotope separation system 100 includes components 1000-6000 configured to perform six distinct functions to match the purification and throughput targets. These functions include vaporization of the irradiated element (e.g., Lu), ionization of atoms of the element, emission and acceleration of element ions, transport of the ions through the system, isotopic separation, and collection. These functions may be accomplished in an ion source assembly 1000, an injector assembly 4000, a velocity separator assembly 4100, a drift path 4900, and an isotope collector assembly 5000. Additionally, the isotope separation system 100 includes supporting subsystems 500-800 providing vacuum and gas management, cooling, power, and overall system control.

The ion source assembly 1000 may be configured to generate ions of a +1 state from a source material, such as lutetium. The ion source assembly 1000 may include a source oven 2000 and a cathode assembly 3000. A charge delivery cask 1500 may be positioned to provide source material to the ion source assembly 1000.

The injector assembly 4000 may be positioned to receive ions from the ion source assembly 1000. In some embodiments, the injector assembly 4000 may accelerate and focus the received ions into a beam.

The velocity separator assembly 4100 may be positioned to receive ions from the injector assembly 4000. In some embodiments, the velocity separator assembly 4100 may comprise a velocity filter with a magnet assembly and two electrodes. The velocity filter may be configured to separate ions based on their velocities as described herein.

The drift path 4900 may extend from the velocity separator assembly 4100. In some embodiments, the drift path 4900 may allow separated ion beams to diverge.

The isotope collector assembly 5000 may be positioned at the end of the drift path 4900. In some embodiments, the isotope collector assembly 5000 may include a first removable collection surface to receive the first target isotope ions.

The isotope separation system 100 may also include an isotope removal cask 6000. In some embodiments, the isotope removal cask 6000 may be used for removing collected material from the isotope collector assembly 5000.

FIG. 1B illustrates one embodiment configuration that may be implemented. As shown in FIG. 1B, the isotope separation system 100 may include multiple access points for power, control, and instrumentation connections. These may include power and control lead access 502, power and control lead access 504, instrument lead access 506, and instrument lead access 508. An instrumentation access port 510 may also be provided.

The isotope separation system 100 may incorporate several supporting subsystems. An instrument & control system 500 may manage operational parameters of the system. A vacuum and gas system 600 may maintain appropriate pressure conditions within the system. The vacuum and gas system 600 may include vacuum turbines 602 and 604, as well as vacuum chamber isolation gate valves 612 and 614.

A power distribution system 700 may provide electrical power to the various assemblies and components. A cooling water system 800 may provide temperature control for components of the isotope separation system 100.

In some embodiments, the isotope separation system 100 may include a vacuum system configured to maintain vacuum conditions during operation. The vacuum system may maintain vacuum conditions in the ion source assembly 1000, injector assembly 4000, separator assembly 4100, drift path 4900, and isotope collector assembly 5000.

Some embodiments may be installed and operated within a shielded hotcell that is capable of separating, isolating, and collecting Lu-177 from an irradiated Lu-176 target. The collected Lu-177 should be of an isotopic purity high enough to ensure a specific activity of no less than 3000 GBq/mg.

The system design may be implemented in a configuration that could be installed and operated within a hotcell.

In such embodiments, the system may include a control unit that could be placed outside the hotcell to provide a user interface as well as primary connections for power, cooling, inert gas, and control signals. From the control rack, the appropriate signals, tubing, and cables may be passed through the hotcell shield wall to be connected into the separator unit.

The operator will physically interface with the source module for inserting the irradiated target and the collector module for extraction of the final product and raffinates. These modules will be removable for loading new targets and extracting collected products, exchangeable in order to allow used modules to decay in storage, so a new module and target may be installed and rebuildable so as to remove wasted product and raffinate from the internal surfaces and to replace eroded, damaged, or used-up sub-components.

Various embodiments of the source module may be designed to produce a circular ion beam, or a ribbon or slot type ion beam, and may be built around a Wien filter type velocity filter.

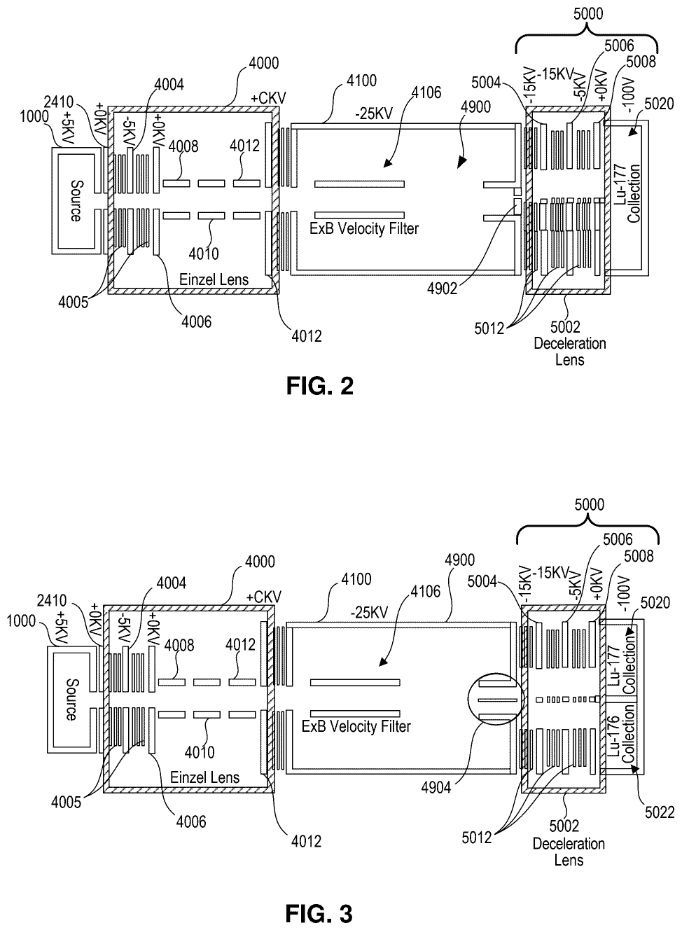

Some embodiments systems are configured as a simple linear device intended to inject ions from the source directly into the separator assembly 4100 as illustrated in FIGS. 2 and 3. The success of these embodiments will be dependent on the achievable ionization efficiency of the source module as well as the effective emittance of the produced beam. The expectation for the performance of this approach is low, but because of the reduced complexity compared to the fully implemented Reverse Neir-Johnson configuration, this design has significant value for early-stage measurement and experimentation.

FIG. 2 illustrates components and elements with some embodiments for separating a single target isotope in a linear separation system 100. As described with reference to FIGS. 1A and 1B, the isotope separation system may include a source assembly 1000, an injector assembly 4000, a separator assembly 4100, and an isotope collector assembly 5000 arranged in a linear configuration.

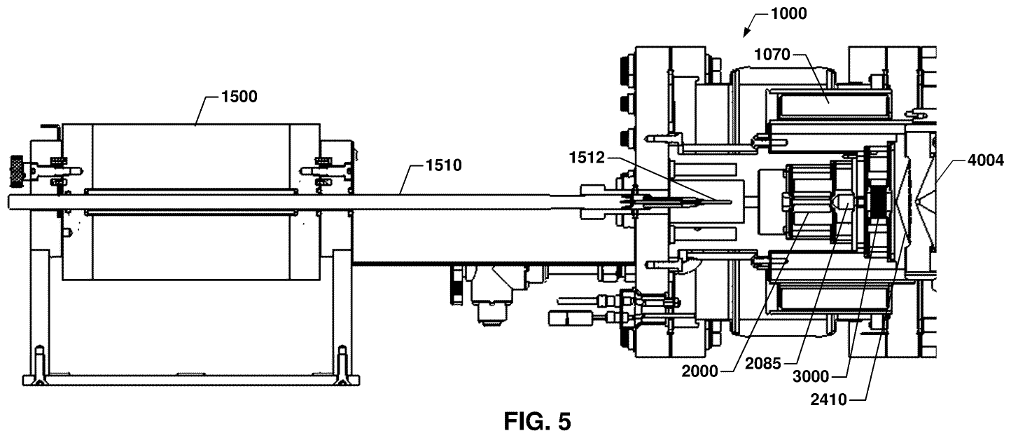

As illustrated in FIG. 2, the injector and lens assembly 4000 may include an accelerator anode 2410, an accelerator cathode 4004, and a ground plate electrode 4006. For example, to accelerate positively charge ions, the accelerator anode 2410 may be at near zero kilovolts (kV), the accelerator cathode 4004 may be held at about negative 5 kV, and the ground plate electrode 4006 may be held at near zero kV. In some embodiments, electrical insulation between these electrodes 2410, 4004, 4006 may be the vacuum between the electrodes (e.g., illustrated in FIG. 5). As illustrated in FIG. 2, in some embodiments, one or more layers of electrical insulation 4005 may be included in the gaps between the electrodes.

The injector and lens assembly 4000 may further include an Einzel lens assembly made up of a first Einzel lens coaxial cylindrical electrode 4008, a second Einzel lens coaxial cylindrical electrode 4010, and a third Einzel lens coaxial cylindrical electrode 4012. A further ground plate 4012 may be included to shield the separator assembly 4100 from electric fields within the injector and lens assembly.

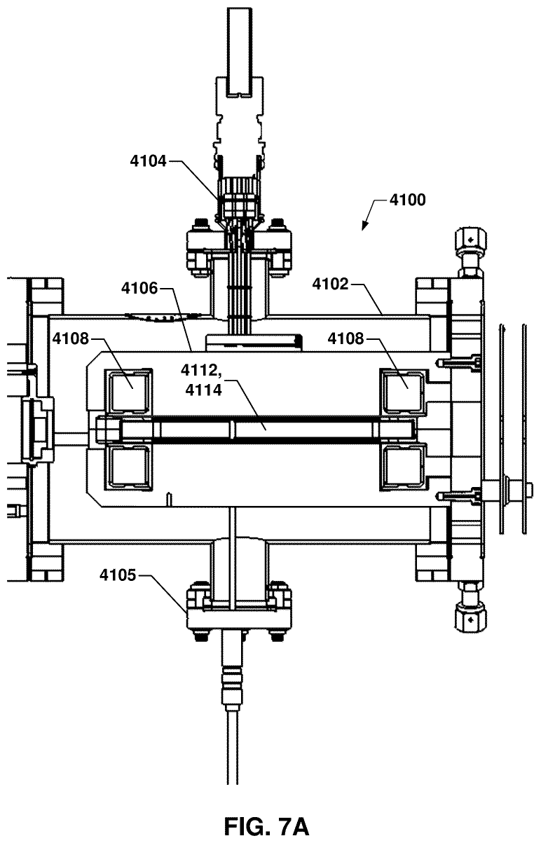

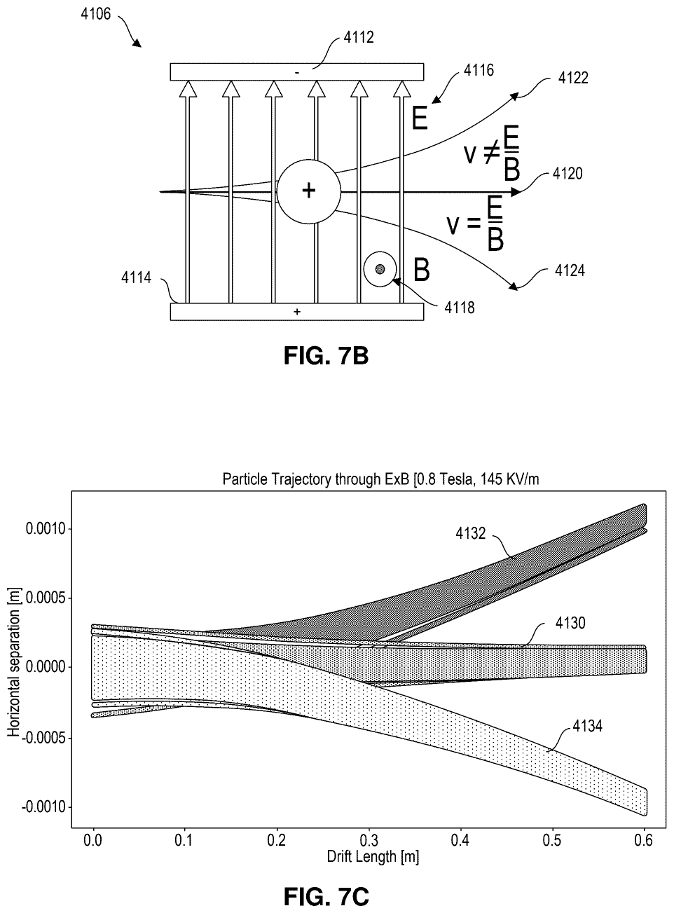

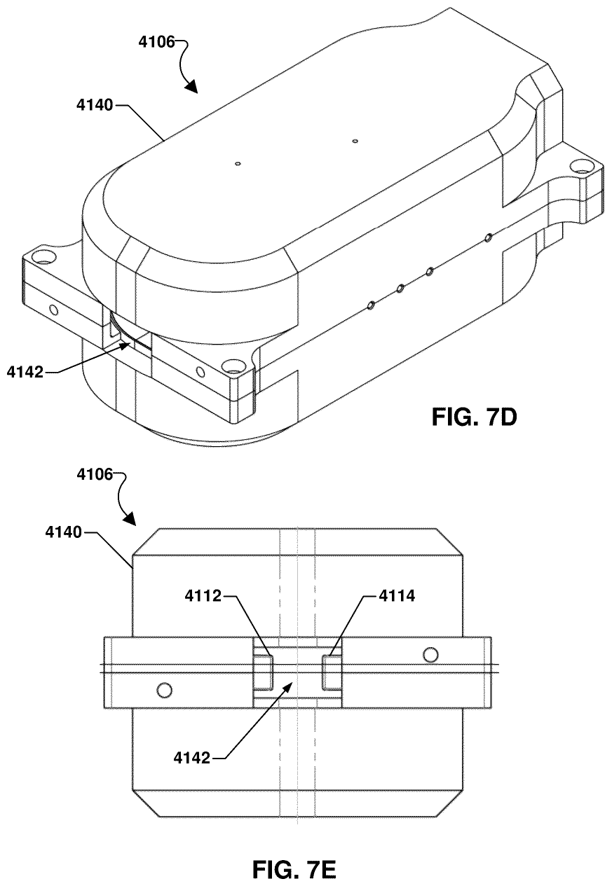

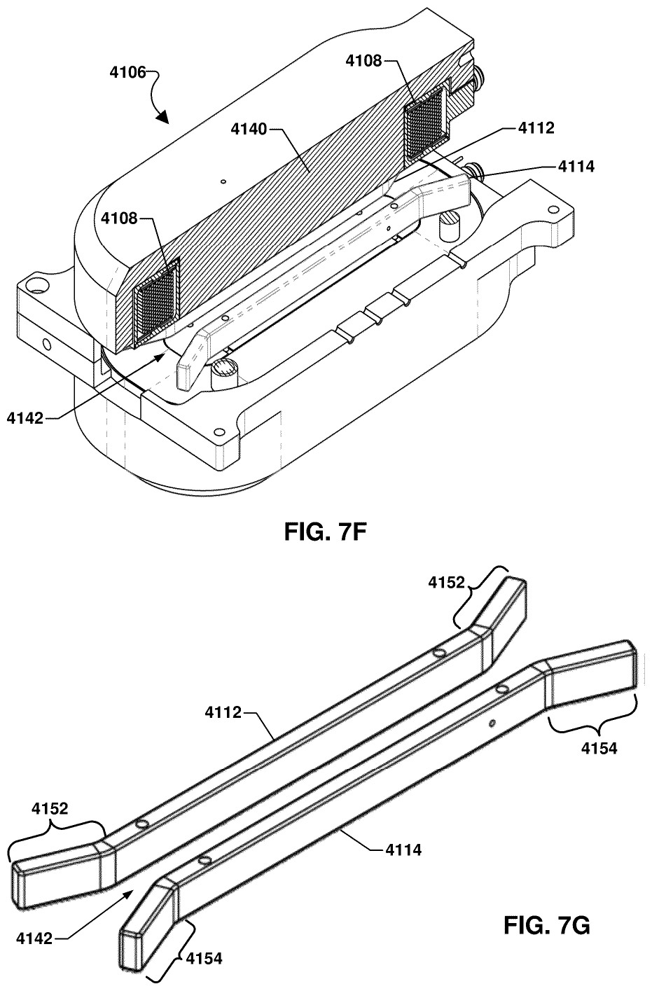

The separator assembly 4100 may be positioned to direct ions that have been accelerated and focused into a beam by the injector assembly 4000 into a velocity separator assembly 4100. As described in detail with reference to FIGS. 7A-7G, the velocity separator assembly 4100 includes a separator filter 4106 in which ions pass through an electric field (E) and magnetic field (B) that are perpendicular to the beam path and one another. By controlling the electric and magnetic field strengths, ions of a target isotope, which travel at one velocity based on the mass of the atoms, may be permitted to pass straight through, while different isotopes and elements traveling at faster or slower velocities due to their different masses are diverted. The diverging beams of non-target isotope ions are permitted to diverge away from the beam of target isotope ions over the drift path portion 4900. The drift path 4900 may have a length sufficient to enable beams of different isotopes exiting the separator assembly 4100 to become sufficiently spaced apart so that target isotope atoms can be isolated using an isotope beam selection collimator 4902. The collimator may be configured so that the beam of the target isotope passes through the first slit aperture while beams of other isotopes are blocked. In some embodiments, the isotope beam selection collimator 4902 may be a slit orifice.

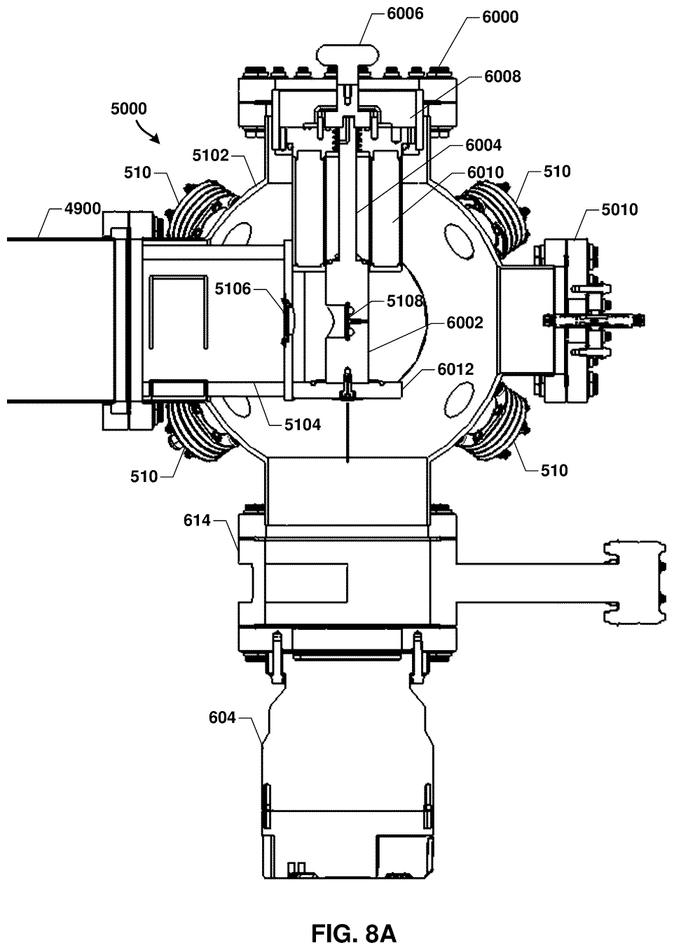

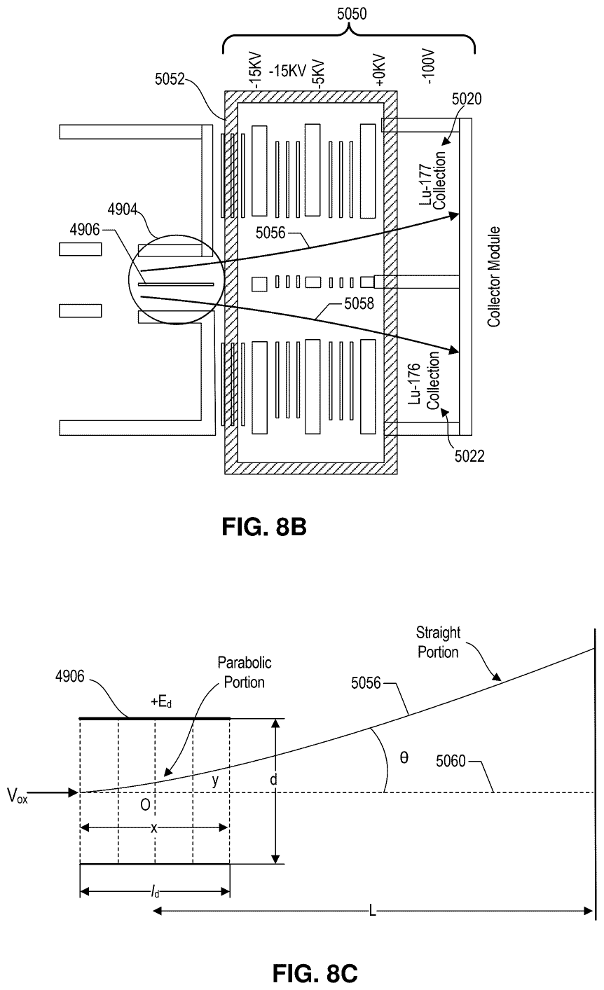

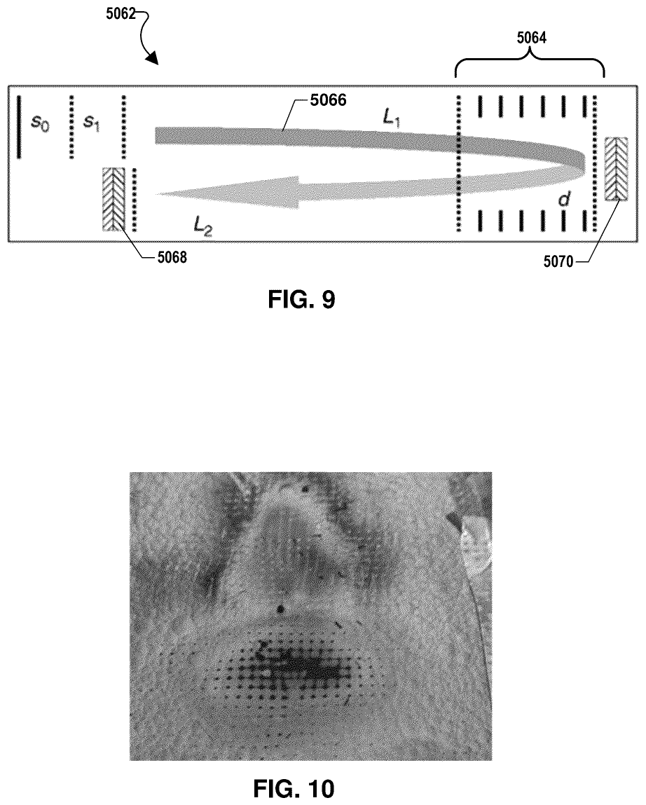

The isotope collector assembly 5000 may be positioned adjacent to the isotope beam selection collimator 4902 and include components for collecting the target isotope atoms. In some embodiments, a target isotope collector 5020 may include the elements described with reference to FIG. 8A. In some embodiments, the isotope collector assembly 5000 may also include a deceleration lens 5002 including a first deceleration electrode 5004, a second deceleration electrode 5006, and a third deceleration electrode 5008. In such embodiments, the deceleration lens 5002 may be controlled to slow the target isotope ions to thermal velocities. For example, the first deceleration electrode 5004 may be maintained at negative 15 kV, the second deceleration electrode 5006 may be held at about negative 5 kV, and the third deceleration electrode 5008 may be maintained at approximately zero kV, thereby generating an electric field configured to decelerate positively charged ions. Insulation 5012 may be provided between components of the isotope collector assembly 5000.

While FIG. 2 illustrates a system configured to isolate a single isotope from the source material, FIG. 3 illustrates a similar linear separation system configured to isolate two or more isotopes by using a beam diverter assembly 4904 instead of a collimator and two or more collector assemblies 5020, 5022. Details of such a beam diverter assembly 4904 are described below with reference to FIGS. 8B and 8C. Such an embodiment may include substantially the same components as described with reference to FIG. 2, although the field strengths of the E and B fields in the velocity filter 4106 may be configured to divert two target isotope beams away from the centerline to line up with either side of the beam diverter plate 4904.

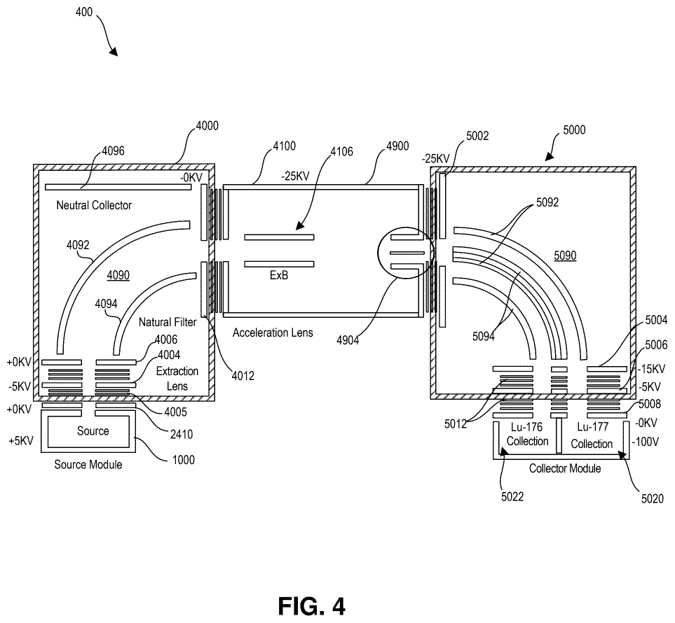

Based on measured performance of the linear configuration the design may be evolved towards a commonly encountered design for laboratory scale mass-spectrometers, known as the reversed Neir-Johnson configuration, as illustrated in FIG. 4.

The primary feature of the Neir-Johnson mass spectrometer is the elimination of second-order angular aberration which enhances the sensitivity and dynamic range of the device without losses to the achievable resolution. The real limitation of this configuration as normally encountered is the limited capability to achieve mass resolutions high enough for isotopic separation in a compact bench-top sized device. This limitation, however, can be overcome by combination with the velocity selector, as illustrated in FIG. 4.

FIG. 4 illustrates an embodiment in which turning magnetic fields are used to curve the paths traced by accelerated ions so that the length of the system can be shortened. Such an embodiment may include many of the components of the linear configurations as described with reference to FIGS. 2 and 3. Additionally, a first turning magnetic field 4090 may be applied to the accelerated ions causing the ions to turn through an angle of rotation (e.g., 90 degrees) passing between electrodes 4092, 4094 that generates an electric field that aids in redirecting the ions. By controlling the strengths of the magnetic field 4090 and the electric field between the electrodes 4092 and 4094, ions of target isotopes can be motivated to follow a patent to enter the separator assembly 4100. Isotopes and elements that weigh more or less than the target isotopes may not align with the entry to the separator assembly 4100, providing a first filter of isotopes. Also, atoms that are not ionized will not be redirected by the magnetic and electric fields will not be redirected and may be captured by a neutral collector 4096.

A second turning magnetic field 4090 and electrodes 5092, 5094 may be included downstream from the separator assembly 4100, drift path 4900, and divert plate assembly 4904 to turn the separated target isotope beams through an angle (e.g., 90 degrees) before entering the deceleration lens (electrodes 5004, 5006, 5008) and the collector module including one or more collector portions 5020, 5022.

Various embodiments include a source module 1000 in which elements from the irradiated target including the target isotope (e.g., Lu-177) are vaporized, ionized, and accelerated into the rest of the system where isotope separation is accomplished. The design of the source module includes components configured to accommodate effects of radioactive decay on the plasma dynamics to form a beam of sufficient current and quality for efficient separation.

Examples of components of the ion source assembly 1000 in some embodiments are illustrated in FIG. 5. A charge delivery cask 1500 positioned adjacent to the ion source assembly 1000. The charge delivery cask 1500 may be configured to provide shielding for the source material during transport and insert the irradiated source element 1512 into the ion source assembly 1000.

The ion source assembly 1000 may include a source oven 2000. The source oven 2000 may be configured to vaporize the source material from the irradiated source element 1512 to generate a vapor of source material atoms including target isotope ions.

In some embodiments, the source oven 2000 may include an aluminum nitride oven core for efficient heat distribution. A conductive ribbon may be wound around the exterior of the oven core for heating. The source oven 2000 may also include a platinum-iridium inner liner for corrosion resistance and a tantalum thermal shield for temperature stability.

The ion source assembly 1000 may further include a cathode assembly 3000 positioned and held at a voltage to generate an electron beam for ionizing the vaporized source material. A magnetic coil 1070 may surround portions of the ion source assembly 1000, including the cathode assembly 3000. The magnetic coil 1070 may help confine electrons emitted by the cathode assembly 3000 into a beam that is directed into a reaction volume 2085 adjacent to the source oven 2000 to cause ionization of the vapor of source atoms. The voltage of the cathode assembly 3000 may be controlled so that electrons entering the reaction volume have energy sufficient to cause single ionization of source atoms while minimizing double ionization. The negative potential of the cathode assembly 3000 causes the positively charge source atom ions to drift to and through the cathode assembly 3000.

In some embodiments, the ion source assembly 1000 may include an emission lens 2410 positioned beyond the cathode assembly 3000. The emission lens 2410 may be held at an electrical potential relative to the negative potential of an acceleration cathode 4004 to accelerate ions into an ion beam into the injector assembly 4000.

The ion source assembly 1000 may be designed with multiple platforms and suspension plates, providing electrical isolation between components. In some cases, the suspension plates may provide electrical connections to the conductive ribbon used for heating the oven core.

The ion source assembly 1000 may include integrated cooling systems for thermal management. These cooling systems may help maintain appropriate temperatures for various components during operation.

The components of the ion source assembly 1000 may be arranged in a linear series of connected chambers and housings. This arrangement may allow for the flow of ions from the source region through the ionization and emission regions in a continuous stream.

In some embodiments, the ion source design may be of the Nier-Bernas type designed to achieve a near-zero emittance matched ion source. The Neir-Bernas type ion source is normally encountered for high-current sources of heavy ions which require some amount of mass analysis or separation. This type of ion source produces a slot or ribbon type ion beam which has distinct advantages over more widely encountered cylindrical beam sources. Such sources can produce currents of heavy ions with linear current densities at the source on the order of 10 mA/cm, but these sources are limited in the beam breadth they can produce, which is a positive attribute for isotopic separation. Slot beam ion sources are most often encountered in semiconductor ion implantation as well as isotope separation, where pure isotopes are required for medical and other purposes. Other unique features of the Neir-Bernas ion source design are: high ionization and utilization efficiency; emission at reasonable electric fields; high beam quality; robust, consistent operation; and ease of operation and manipulation.

The primary differentiator of various embodiments compared to the common Neir-Bernas ion source will be the operating temperature of the vaporizer and the mechanism by which the vaporizer is implemented. The vaporizer is handled as completely separate assembly from the ionization chamber, this feature is beneficial for most high-current applications which are intended for high-dose implantation for semi-conductors and for which are usually specified to handle 50-100 gram quantities of material. Because of the limited quantity of vaporizable material for the irradiated targets (100 mg), it is unlikely that a discrete and separate vaporizer would be able to develop sufficient pressure to feed material into the ionization chamber at high efficiency. Instead, this concept will place the irradiation target directly into the ionization chamber to act as a second indirectly heated cathode in place of the anticathode of a typical Neir-Bernas ion source.

As the primary function of the source module is to form the ion beam to be isotopically separated, this source module must be designed to implement 3 specific sub-functions specific to use for this application: Vaporization of lutetium metal, ionization of lutetium metal, and extraction of lutetium ions.

Vaporization for a Neir-Bernas ion source is usually limited to high vapor pressure elements, as the materials of its construction are constrained to temperatures of less than 800 degrees C. (° C.) and theoretically cannot function above 1000° C. In order to function for use with lutetium, the vaporizer of this concept must be capable of stable operation up to at least 1700° C. This would normally be difficult for a large mass vaporizer, but in this specific application where the vaporizable mass is very small, this limitation can be overcome by incorporating the vaporizer directly into the ionization chamber where temperatures normally exceed 2000° C., and which is composed of high-temperature refractory metals. The majority of the engineering effort for this aspect of the source module will be to ensure that the target material can be vaporized at a stable and controlled rate which will be necessary to ensure both high-efficiency mass throughput and high-resolution isotopic separation.

While the achievable vaporization temperature is the directly measurable metric for this aspect of the source performance, the primary parameter driving the vaporizer design is actually the vapor density within the ionization chamber. Paradoxically, while establishing a high vapor density ensures a high ionization efficiency, it also results in a lower utilization efficiency as loss of neutral vapor atoms is driven by pressure-based diffusion. In light of these competing mechanisms, a balance must be developed between these aspects to maximize the vapor density while minimizing the vapor pressure. As the plasma dynamics of the ionization chamber have yet to be fully defined, it's quite possible that this source can operate quite successfully at a lower operating temperature, while still being capable of high-efficiency ionization and utilization.

In order to be accelerated by electrostatic fields up to the energy necessary for isotopic separation, the neutral lutetium metal vapor formed within the source module must be ionized into the +1 charge state by removal of an electron. While many methods of ionization are known and utilized for industrial processes, each having specific attributes, limitations, and applications, only a few specific ionization techniques have been evaluated for this system concept due to their applicability, simplicity and low technical risk. In future optimization work, which is outside the scope of this concept, other ionization techniques may be investigated including laser resonance ionization, electron cyclotron resonance ionization, and/or chemical ionization.

Ionization of a vaporized or gas phase neutral atom by collisions with electrons is the most fundamental kind of ionization mechanism. In this concept for the source module, thermal electrons are produced by thermionic emission from an indirectly heated cathode and are accelerated into the arc chamber. A magnetic field is oriented axially to the plasma chamber to induce a cycloidal trajectory of the electrons as they are confined to the magnetic field lines transiting the arc chamber and remain confined in the central area until their energy is sufficiently low enough to be removed from the plasma volume.

The free electrons in the vapor, preestablished by controlled thermionic emission from the indirectly heated cathode, are accelerated by an applied electric field to an energy sufficient to cause ionization when they collide with a neutral vapor phase atom. In the collision, more free electrons are created, and the discharge grows. Ionization in this manner is a stochastic process which proceeds at a rate determined by the energy-population of the electrons, the density of neutral vapor, and the magnitude of secondary ionization mechanism (ion impact, charge exchange, excitation, neutralization, etc.) though a certain minimum energy is needed from the electron-neutral collision for ionization to occur. The electron energy must exceed the energy needed to remove the outermost bound electron from the neutral atom, called the ionization potential, or more specifically, this is the first ionization potential, referring to removal of the first electron. The probability of ionization increases with electron energy, rising from zero for energy just below the minimum ionization potential up to a maximum for an electron energy about three to four times the minimum value [FIG. 19].

In a plasma there is a distribution of energies and the mean electron energy is described by 3/2K_{b} Tₑ where Tₑ is the plasma electron temperature. This is yet another aspect of the specific application that needs further study as the radioactive decay of lutetium at the beginning of processing will produce a high-energy electron current of ˜19 mA (4 watts), assuming a Lu-177 activity of 3200 Ci.

Electrons from the radioactive decay will be a minor fraction of the total electron population of the plasma, but will be expected to dominate the plasma temperature and kinetic behavior due to upcharging, nuclear recoil, and the resultant secondary electron emission.

The primary method of enhancing the ionization process is to provide good plasma confinement, both for the primary electrons doing the ionization as well as for the positive ions that are created. This usually means that the plasma formation process is done within a magnetic field.

The probability of ionization is determined by the total ionization cross section, and the effective rate of ionization is correlated to the following relation:

$${N}_{n} * {σ}_{n} ( {T}_{e} ) * {ϕ}_{e} ( {T}_{e} ) = {\sum }_{Z = 0}^{Z = 71} {ϕ}_{i}^{Z} ( {T}_{i} ) ,$$

where: Nₙ=number of neutral atoms; Tₑ=electron temperature;
σₙ=electron impact cross-section; ϕₑ=electron population;
ϕᵢ=ion population; Tᵢ=ion temperature; and Z=ionization charge state.

Based on calculations performed using the Binary-Encounter-Bethe model, the total electron impact first ionization cross-section has been calculated from the Hartree-Fock wave function parameters for lutetium. Without experimental values to compare against, the validity of the values is suspect but should be sufficient for further development of the appropriate detailed design for the source module.

The ion source extraction consists of at least 3 components. First, the emission plate of the ion source divides the ionization chamber from the beamline and includes an aperture to define the initial geometry of the beam. The size and shape of the aperture are matched to both the plasma density within the ionizer as well as the downstream electrode apertures. The next element is the emission electrode, which provides the electric field for accelerating the lutetium ions from the ion source to form an ion beam. The last element is the suppression electrode which prevents electrons formed from secondary interactions downstream from being accelerated into the ion source, which would cause excessive heating and erosion of the exposed surfaces as well as perturbations in the plasma behavior.

The injector assembly is responsible for conditioning the beam for separation. As much of the behavior anticipated for the beam due to the radioactive decay of the Lu-177 has yet to be fully defined, the elements of the injector assembly are intended to perform three primary functions: species selection, focusing, and acceleration.

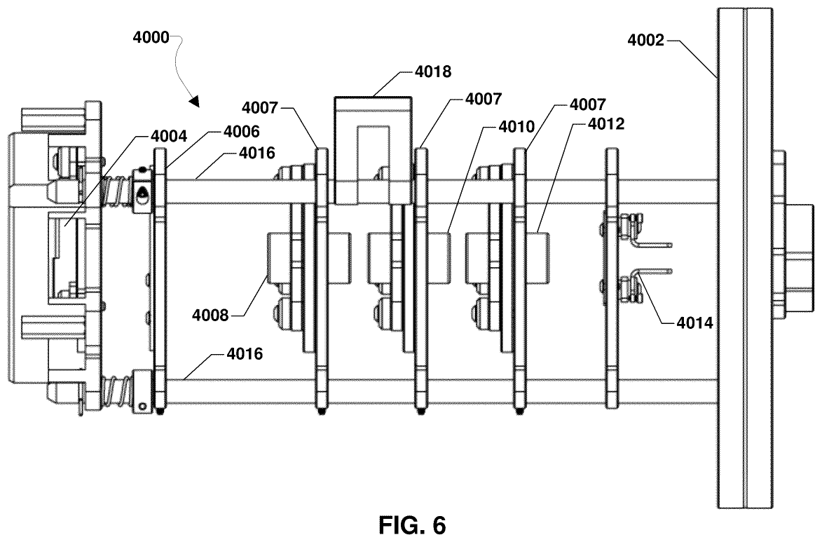

FIG. 6 illustrates the injector assembly 4000, including an accelerator and lens assembly according to some embodiments. The accelerator and lens assembly 4000 may include a mounting flange 4002 at the top portion that provides structural support and attachment points. Beyond the mounting flange 4002, the assembly may include an accelerator electrode 4004 that establishes the electric field for accelerating ions up to a velocity selected to enable separation of isotopes in the separator assembly 4100 (FIG. 7). A ground plate electrode 4006 may be included between the accelerator anode 4004 and the Einzel lens electrodes 4008, 4010, 4012 to minimize interference of the accelerator electric field with the electric fields of the lens elements.

As mentioned above, the injector assembly 4000 may include three Einzel lens coaxial cylindrical electrodes arranged in sequence: a first Einzel lens coaxial cylindrical electrode 4008 held at a near zero kV potential, a second Einzel lens coaxial cylindrical electrode 4010 held at a high kV potential (e.g., +10 kV) to focus ions on the collection plane, and a third Einzel lens coaxial cylindrical electrode 4012 held at a near zero kV potential. These electrodes are aligned concentrically along the long axis of the assembly and the ion beam path.

The assembly may include mounting brackets 4007 and support rods 4016 that extend vertically through the structure to provide mechanical support and alignment for the various electrodes. The mounting brackets 4007 may secure the electrodes to the support rods 4016 while maintaining electrical isolation between components.

A vertical deflector 4014 may be positioned near the output of the injector assembly 4000. The vertical deflector 4014 may be configured to adjust the trajectory of particles passing through the assembly to ensure the beam is aligned with the centerline of the system, and particularly the input to the separator filter 4106 in the adjacent separator assembly 4100 (see FIG. 7A).

In some embodiments, the injector assembly 4000 may include a plug assembly that serves as a quick-connect mechanism for electrical connections. The plug assembly may include press-fit pin receptacles for electrical connections. In some cases, the plug assembly may consist of a base part with four arms that snap onto the uppermost rails of the assembly.

The plug assembly may include a PCB-like structure with laser-cut metal traces. In some embodiments, set screws on the plug assembly may clamp the wires from the lens elements to the metal traces, ensuring secure electrical connections.

The components of the accelerator and lens assembly may be arranged in a stacked configuration, with the support rods 4016 maintaining proper spacing and alignment between the electrodes. This arrangement may allow for efficient acceleration and focusing of the ion beam as it passes through the assembly.

It is unlikely that ionization will be 100% efficient, or that the extracted beam will only be composed of the elements lutetium and hafnium. In order to prevent these non-product species from dominating the behavior of the beam, the injector may be engineered to reject ions outside of a specific mass-energy range defined by the design of the separator assembly 4100, thereby selecting the mass species that is allowed to be transmitted into the separator.

After emission from the ion source, the ion beam will immediately begin to grow due to the inherent space charge forces exerted by the charged particles of the beam. The injector will be capable of the minimum amount of focusing necessary to control further expansion of the beam. While correction of the beam emittance is expected to be performed by collimation via the beam-defining aperture, an appropriate amount of focusing power will decrease the amount of ion rejection required for collimation, thereby increasing the overall transport efficiency.

To keep the size of the isotope isolation system within a reasonable envelope, the energy of the lutetium beam may be limited to a range of around 10 keV. Higher energies would require a larger path length through the magnetic dipole, increasing the overall length of the device. While 10 keV may be sufficient for effective separation through the separator, the beam does become more sensitive to space charge effects. In some embodiments, space charge sensitivity may be addressed by implementing a post-acceleration type of configuration, in which the beam is further accelerated in the region between the magnetic dipole and the beam-defining aperture of the separator assembly 4100.

Referring to FIGS. 7A-7G illustrate components that serve to separate the target isotope (e.g., Lu-177), which include a separator assembly 4100, with additional separation achieved by permitting the separated ion beams to diverge over an extended drift path 4900. The separator assembly 4100 is a primary component of the system, responsible for the isotopic separation.

The velocity selector 4100 includes a velocity filter 4106, which is a device that implements perpendicular electric and magnetic fields that can be tuned to adjust the trajectory of ions as they traverse the device. Also referred to as a Wein filter, velocity filters are commonly encountered in ion beam applications to select particles based on their speed, which depends on the atomic masses when ions are accelerated by a given electric field. Within the velocity filter 4106, the electric and magnetic fields induce opposing forces on the charged particles, the electric field pushing the ion in one direction, while the magnetic field pushes the particle in the opposite direction.

Any charged particle in an electric field will feel a force proportional to the charge and field strength such that:

$$F = qE ,$$

where: F=force; q=charge state; and E=electric field.

Similarly, any particle moving in a magnetic field will feel a force proportional to the velocity and charge of the particle. The force felt by any particle is then equal to:

$$F = qV \times B ,$$

where in addition: V=ion velocity; B=magnetic field; and V×B=cross-product of V and B.

In the case of a velocity selector, the magnetic field is always at 90 degrees to the velocity, so force is simplified to F=qVB.

Setting the two forces to equal magnitude in opposite directions, it can be shown that V=E/B.

This means that any combination of electric and magnetic fields will allow charged particles with only velocity V through. As the sum of those forces is reduced to zero, and the resulting particles pass fully through the device without any changes to their trajectory or energy. For particles travelling at a velocity above or below that value, the electric field will induce a dominant force causing the trajectory to curve towards one side or the other. This effect allows ions of similar energy and different mass to be separated within a very short path length compared to purely magnetic mass analysis. The limitation of these devices tends to be the maximum beam current, as space charge effects will dominate the effective force on the charged particles.

Determining the specifications for the separator assembly 4100 needs to address several coupled parameters for a suitable design: the minimum physical separation of mass species; the velocity of the mass species; and the drift length of the velocity filter 4106.

The separator assembly 4100 may include a velocity filter 4106 as illustrated in FIG. 7A. The separator assembly 4100 may be contained within a reducing cross containment cylinder 4102 that houses the internal components. A power plug access port 4104 and an instrumentation lead access port 4105 may be provided on the reducing cross containment cylinder 4102 to enable electrical and control connections to the velocity filter 4106.

The velocity filter 4106 may include magnet windings 4108 arranged to generate a magnetic field that is perpendicular to the beam path. The magnet windings 4108 may include copper wire coils that are elongated to stretch the high-flux magnetic field located in the core for the length of the elongated coil, thereby maintaining a mostly equal magnetic field along the length of the filter.

A first electrode 4112 and a second electrode 4114 may be positioned within the velocity filter 4106. The first electrode 4112 and second electrode 4114 may be oriented and energized to generate an electric field perpendicular to the beam path and to the magnetic field produced by the magnet windings 4108. The first electrode 4112 and the second electrode 4114 are arranged parallel to each other with a gap between them that forms the passage for the ion beam through the filter. Further, the first electrode 4112 and second electrode 4114 may be angled to vary the electric field to compensate for non-linearities in the magnetic (B) field so that the ratio of the electric field strength to the magnetic field strength remains approximately constant within the volume of the velocity filter.

The velocity filter 4106 serves to separate different isotopes into separate ion beams based on their velocities. As ions are accelerated in the electric field generated at the entrance to the injector assembly 4000 to velocities that depend on the mass of individual atoms, heavier isotopes (e.g., Lu-177) will be traveling slower than lighter isotopes (e.g., Lu-176), which then enter the velocity filter 4106. As illustrated in FIG. 7B, ions moving through electric and magnetic fields are accelerated based on their velocities. Faster moving ions are accelerated more by the force applied by the magnetic field and so will accelerate, and thus their beam path will bend in one direction. In contrast, slower moving ions are accelerated more by the force applied by the electric field due to the longer time spent in the electric field, thus bending their beam path in the opposite direction. This enables the velocity filter 4106 to steer isotope ions into diverging beams 4130, 4132, 4134 as illustrated in FIG. 7C.

In some embodiments, the system may apply power to the electrodes and magnet windings to control the electric and magnetic fields of the velocity filter 4106 so that a target isotope beam path 4120 passes straight through the filter without deflection, while a heavier slower isotope/ion beam path 4122 and a lighter faster isotope/ion beam path 4124 are deflected in opposite directions as illustrated in FIG. 7B. In some embodiments, the system may apply power to the electrodes and magnet windings to control the electric and magnetic fields of the velocity filter 4106 so that beams of two or more target isotope ions are steered into paths that enable separation at the end of the drift path 4900 as described herein with reference to FIGS. 8B and 8C.

As illustrated in FIGS. 7D and 7E, the velocity filter 4106 may be included within a ferrous body 4140 that forms the electromagnet, contains the electrode elements, and provides a beam path 4142 through the magnet and between the electrodes 4112, 4114. FIG. D only shows the portions of the velocity filter that include the ferrous yoke, the electromagnet coils, and the electrodes. These are the parts responsible for making the B-field, E-field, and matching these fields to one another within the ion beam path. The complete velocity filter assembly includes more components, such as a structural mounting flange, electrical connectors, sealing features, and other structures and components.

FIG. 7F shows a cutaway view of the velocity filter 4106 that reveals the ferrous body 4140 and the windings 4108 of the electromagnet. The ferrous body 4140 may surround the electromagnet windings to generate a near-constant magnetic field between the windings.

FIG. 7F also shows the location and orientation of the electrodes 4112, 4114 with respect to the beam path 4142, the magnet core 4144, and the magnet windings 4108. In particular, FIG. 7F shows how the electrodes 4112, 4114 curve in the vicinity of the windings 4108, including curved or bent portions 4152, 4154 as illustrated in FIG. 7G.

A key element to providing a system that exhibits high mass recovering of target isotope(s) involves shaping the electrodes 4112, 4114 of the velocity filter 4106 so that the ratio of the electric field strength to the magnetic field strength remains approximately constant over the entire length of the filter. Conventional velocity filters may result in low yields because the magnetic field within the beam path of the filter is not constant. This is due to the nature of magnetic field lines near the windings. Various embodiments overcome the limitations of conventional velocity filters by shaping the electrodes 4112, 4114 to account for and accommodate non-linear elements of the magnetic field, thereby maintaining the ratio of the electric field strength to the magnetic field strength approximately constant within the volume of the velocity filter.

In some embodiments, the electrode design may be arrived at using the Monte Carlo method. In such design methods, the electrode geometry may be parameterized and calculated using several thousand combinations. This design process may involve normalizing the simulated electric field generated by an electrode shape or configuration, and then subtracting out the normalized magnetic field. A suitable electrode design may be determined by minimizing the error between the normalized electric and magnetic fields.

In some embodiments, the first electrode 4112 and the second electrode 4114 may each include curved portions 4152, 4154, respectively, at their ends. These curved portions 4152, 4154 are shaped to maintain a consistent ratio between electric and magnetic field strengths along the entire beam path 4142, including where the magnetic field begins to change due to the positioning of the magnet windings 4108. Without the curved portions in the electrodes, either the magnetic or electric field effects would dominate, causing an undesired redirection in the isotope ion beams that can reduce the separation or isolation efficiency of the rest of the system.

After passing through the velocity filter 4106, the ion beams may separate into a target isotope beam 4130, a heavier, slower isotope/ion beam 4132, and a lighter, faster isotope/ion beam 4134, with increasing spatial separation between these beams occurring over the drift path 4900. This separation may allow for the selective collection of the desired isotope in the isotope collector assembly 5000.

In some embodiments, the injector and velocity filter sections of the system may include other components that are not shown in the figures, such as a beam defining aperture, a mass resolving aperture, a mass scanning deflector, and a deceleration column.

The beam defining aperture is an exchangeable aperture of a fixed size, shape, and position which is installed at the entrance of the separator. This aperture is responsible for rejecting ions outside of the acceptable mass-energy range for separation. Further, this aperture allows the beam width to be rigidly defined and matched to the final achievable physical separation of the post-separated beams. Lastly, in the event of excessive space-charge emittance growth, this aperture can be used to reset the beam to a zero-emittance condition by intercepting and rejecting ions at the extents of the beam envelope, further conditioning the beam to produce the best possible separation between the product and raffinate streams.

The mass resolving aperture is an exchangeable aperture of a fixed size, shape, and position that is installed at the exit of the separator. The mass resolving aperture is responsible for preventing the transmission of ions outside of the mass-energy envelope into the collector, which includes up-charged and scattered ions that form within the separator. The aperture geometry is expected to match the product and raffinate beam shapes at the point of its installation.

Depending on the final achievable mass resolution, the size of the mass resolving aperture can be changed to increase or decrease the amount of beam that is allowed to be transmitted into the analyzer as needed to adjust either the specific activity of the final product or the mass throughput of the system.

The mass scanning deflector is a thin metallic plate, electrostatically biased relative to and located immediately behind the axial center of the mass resolving aperture.

The purpose of this feature is twofold. The first and primary function of the mass scanning deflector is to intercept the beam, similar to a wire profilometer, in order to directly measure the integrated vertical beam intensity as a function of the beam's transverse position in the mass resolving aperture. The electrostatic bias ensures that the formation of secondary electrons is suppressed and that a high-fidelity measurement of the beam current intersecting the deflector occurs. This allows the full transverse beam shape and intensity to be mapped by sweeping the separator parameters. During steady-state operation, the separator parameters are set to ensure the deflector measurement is maintained at the non-zero minimum current point, which is centered between the mass peaks of Lu-177 and Lu-176. This ensures that any deviation from the optimal separator parameter settings presents as an increase in response and can be easily adjusted. The second function of this feature is to increase the angular trajectory and physical separation of the individual mass peaks on either side of the deflector as they are transported towards the collector module, while also preventing the re-mixing of mass species during deceleration.

For efficient collection and emission of the product and raffinate streams, the ions may be gradually slowed to thermal energies. The deceleration column provides the necessary electrostatic potentials to gradually slow the ions while controlling the beam expansion and defocusing to maintain high transport efficiency.

The collector module 5000 is the last element in the design of the primary components. The collector modules will be user-replaceable during operation so that the product may be collected at multiple points during processing of a single target. The collector will allow the slowed ions entering the collection volume to be neutralized and deposited as a thin metallic film. While the collector module does not need to implement significant complexity, it may be advantageous to implement the following features in the event of cross-contamination between the product and raffinate streams.

The ion reflector-suppressor assembly 5062 may include deceleration lens 5064 that includes electrodes configured and charged to first slow ions and then reflect the target isotope ions back to the target isotope collector 5068. Using an ion reflector-suppressor assembly 5062 allows the ions to be further slowed from a minimum transport energy of 5 keV to thermal energies, while also allowing the removal of the target isotope collector surface 5068 from having a line of sight with the separator assembly 4100. For example, the electrode elements 5064 may be configured and maintained at potentials that redirect ions 5066 traveling along a first ion path L1 to follow a second ion path L2 to the collector 5068.

Neutral atoms in the beam will not be reflected and may be absorbed in a neutral atom absorption surface 5070, which may be positioned beyond the deceleration lens 5064 to capture atoms and ions that are not reflected toward the collector. Capturing neutral atoms in the neutral atom absorption surface 5070 reduces the probability of neutral un-separated atoms from being collected, as well as suppressing the re-emission of secondary ions formed from ions impacting the collection surface, as well as preventing secondary electrons from neutralizing the beam species while still at transport potential.

The ion collection surface may be in the form of a high-purity graphite plate, carbon foil, carbon felt, or carbon fiber mesh that provides appropriate thermal cooling and surface adsorption potential for the thermal ions to be captured. The collection surface material is selected to be chemically inert, process-compatible, and non-interfering. FIG. 10 is an illustration of an ion collection surface after exposure to a beam of ions, showing in the discolored region how the target isotope may be accumulated on the surface.

The collection surface should also provide a stable substrate to physically stabilize the collected mass to prevent loss or transfer during handling, from chemical reactions, or physical removal as dust, flakes, or granules.

The collection surface is expected to be conductive yet non-metallic, which is helpful in grounding the collection surface to minimize charge buildup during deposition. The collection surface should also be of high enough purity to prevent introducing trace contaminants into the product.

To reduce the probability of secondary electrons, which are liberated during impact of neutralized ions on the collection surface, from being accelerated through the deceleration column, the reflector surface will be appropriately biased to capture stray electrons.

Extracting the collected product and raffinates from the collection surface after the module has been removed from the system is anticipated to be performed by injection of liquid solvent into the collector volumes. Both product (Lu-177) and raffinate (Lu-176 & Lu-175) material streams may be independently dissolved into the liquid solvent and extracted by liquid pumping directly into the purification process.

A number of ancillary systems may be included in the system design to perform all of the primary functions as specified. While these systems in some embodiments have been sized or specified based on either experience or conservatively calculated by approximation appropriate for this application, where possible, some minor changes may be implemented in various embodiments and implementations.

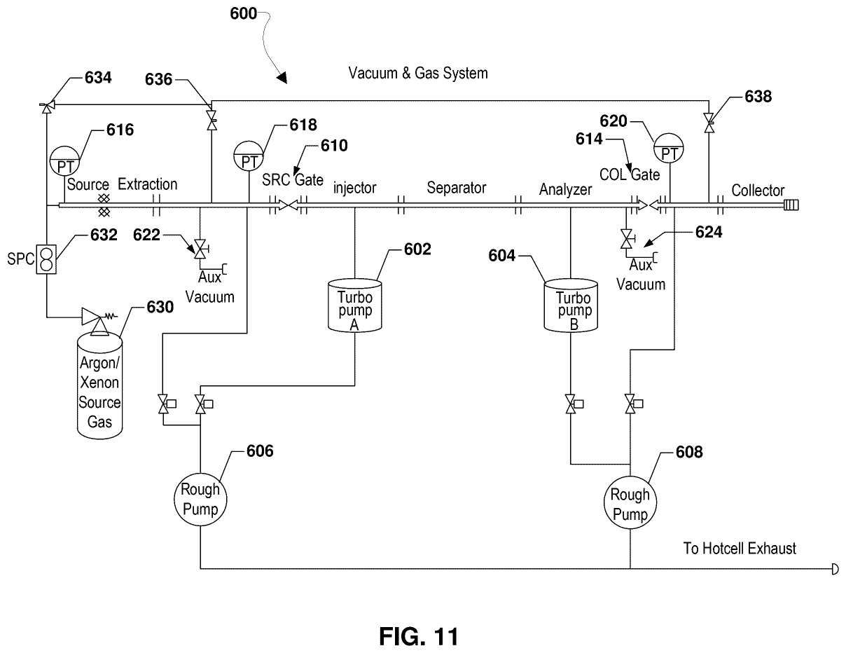

FIG. 11 illustrates an example vacuum and gas system 600 that may be used in various embodiments for managing vacuum conditions, inert gases, and conducting purging, as illustrated in FIG. 11. The vacuum and gas system 600 may be configured to establish and maintain vacuum conditions and provide overall control of gases during system calibration, isotope separation operations, and removal of collected isotopes. The vacuum and gas system 600 may include multiple vacuum pumps and turbines to maintain the required vacuum levels. In some embodiments, the system may include two vacuum turbines 602, 604 and two vacuum pumps 606, 608 arranged in parallel configurations. This parallel arrangement may provide redundancy and ensure consistent vacuum performance throughout the system.

In some embodiments, the vacuum and gas system 600 may include several vacuum chamber isolation gate valves 610, 614. These gate valves may allow for isolation of different sections of the vacuum system, which may enable removal of collected isotopes from the collector assembly 5000 without the need to repressurize the rest of the system (e.g., portions 1000-4900). The ability to isolate parts of the system may also be useful for maintenance or troubleshooting purposes.

The vacuum and gas system 600 may incorporate multiple pressure taps 616, 618, 620 positioned at various points in the system. These pressure taps may be used to monitor vacuum levels at different locations within the isotope separation system.

In some cases, the vacuum and gas system 600 may include an auxiliary vacuum valve 622 and a vacuum valve 624. These valves may provide additional control points for vacuum management, allowing for fine-tuning of the vacuum conditions in specific areas of the system.

The vacuum and gas system 600 may also incorporate components for gas control and purging operations. In some embodiments, the system may include a test source/purge gas supply 630 connected to a test source/purge gas regulator 632. Purge gas valves 636, 638 may be included in the vacuum and gas system 600 to regulate the introduction of purge gases into different sections of the vacuum system. These valves may enable precise control over purging operations when needed. This arrangement may also allow for the controlled introduction of purge gases into the system to reduce corrosion due to exposing certain materials to oxygen. The purge gas system components may also support providing a controlled amount of an inert gas (e.g., Xe) into the system for use in calibrating the various electric and magnetic fields of the system before introducing radioactive source materials into the ion source 1000.

In some cases, the vacuum and gas system 600 may be configured to connect to a hotcell exhaust. This connection may allow for proper ventilation of any gases generated during system operation, ensuring safe handling of potentially radioactive or hazardous gases.

The vacuum and gas system 600 may be designed to maintain appropriate vacuum conditions throughout the isotope separation system, including the ion source assembly 1000, injector assembly 4000, separator assembly 4100, drift path 4900, and isotope collector assembly 5000. In some embodiments, the system may be capable of achieving a minimum base pressure of approximately 5×10−7 Torr and maintaining a nominal background pressure of no more than approximately 7×10−6 Torr.

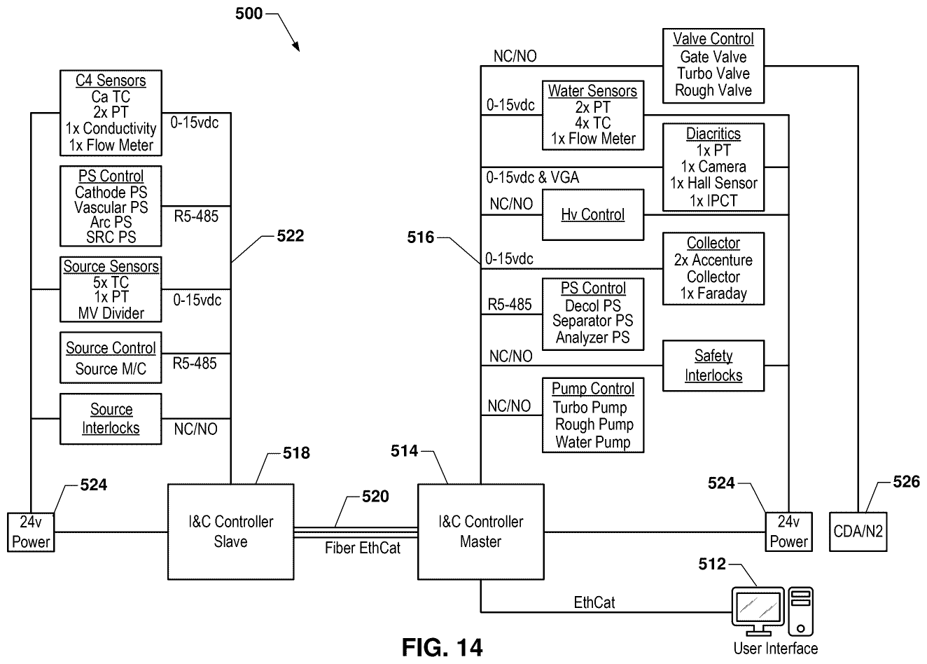

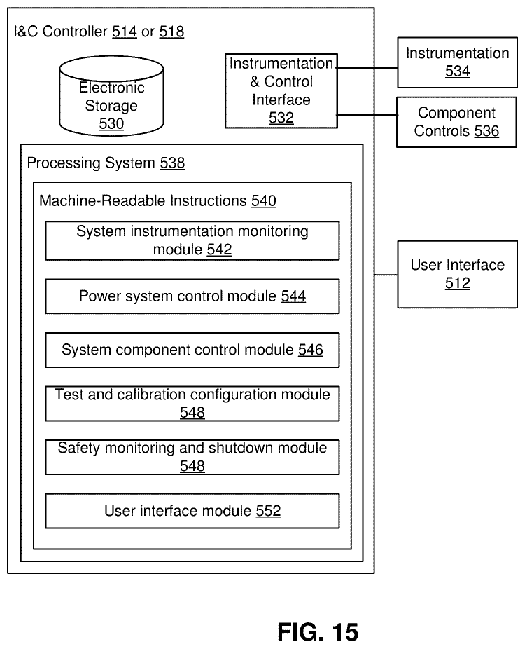

The vacuum and gas system 600 may be controlled and monitored by the instrument & control system 500 (FIG. 14), which may adjust vacuum levels and gas flow rates as needed to optimize the isotope separation process. In some cases, the vacuum and gas system 600 may interface with other subsystems, such as the cooling water system 800, to ensure proper operation of all components under vacuum conditions.

As an example, the vacuum system may maintain a minimum base pressure of ˜5×10−7 Torr and a nominal background pressure of no more than 7×10−6 Torr, assuming a large in-leakage from the multiple O-ring sealed surfaces. Further, inert gas is expected to be injected directly into the system during certain tests or experiments, which will present as a steady state gas load in order to observe the effects of space charge compensation on the quality of the beam. Lastly, the system has been designed to allow the ability to produce a glow discharge appropriate for minor surface sputtering during vacuum conditioning, which may result in a mixed high-vac/low-vac operating mode.

The maximum steady state gas load, including in-leakage, is expected to be no more than ˜178 Torr-L/s of argon. Each of the Turbopumps has been specified for 250 Torr-L/s @1×10−6 Torr, which should provide a significant margin in the event of either excessive in-leakage or heavier gas loading than anticipated.

Each of the inline vacuum valves is expected to be bellows-sealed pneumatically actuated vacuum valves, while the auxiliary valves will be manual bellows-sealed valves. The gate valves associated with the source and collector modules will be of the pneumatic self-sealing, insertable type. The roughing pumps have been initially specified as appropriately sized diaphragm pumps. In the event these are insufficient for certain experiments, the auxiliary vacuum connections may be used for connection to larger scroll-type roughing pumps.

Inert noble gases are to be utilized during several startup and maintenance tasks requiring the availability of multiple connection points as well as appropriately sized over-pressure protection.

The gas system may incorporate a lecture bottle size source gas bottle of inert gas. It is possible that during vent and purge operations, such a small volume may not be sufficient, and so may be augmented by attaching a larger source of inert gas to the auxiliary ports during testing. The purpose of the lecture bottle source gas is to allow the source and all of its inputs to be electrically isolated from ground.

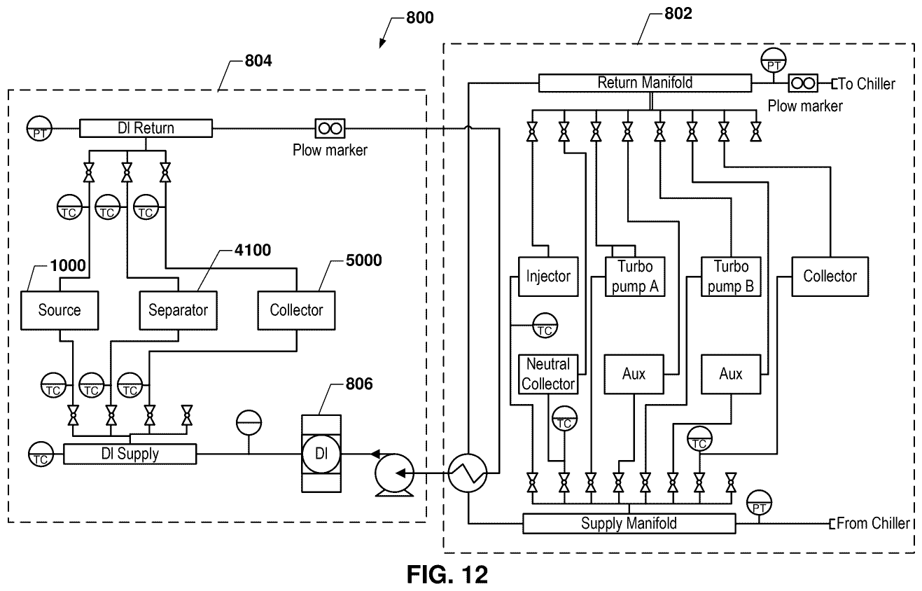

FIG. 12 illustrates an example cooling water system 800 that may be deployed in the isotope separation system 100 to provide temperature control for various components of the system. In the illustrated example, the cooling water system 800 includes two main subsystems: a chill water system 802 and a deionized chill water system 804. In some cases, these subsystems may operate in parallel to provide cooling to different components of the isotope separation system. However, in some embodiments, only a single subsystem may be used in which all cooling water is deionized.

Cooling for the system will be provided in two coupled cooling loops. Since several cooled surfaces within the system must be maintained at high relative voltage, closed-loop deionized water may be used. For the remainder of the components and surfaces requiring direct cooling, a ground-side laboratory-size chiller will be used. Until the detail design is complete, the exact heat loading is unknown but is not anticipated to exceed 1200 watts total. For the purpose of temperature control and process monitoring, liquid flow meters and thermocouples are implemented at multiple points to provide indirect calorimetric monitoring.

The chill water system 802 may be connected to the separator assembly 4100 and the isotope collector assembly 5000 to provide cooling to these components to maintain proper operating temperatures during the isotope separation process.

The deionized chill water system 804 may be connected to the ion source assembly 1000 and other components that include high-voltage elements. Supplying deionized cooling water to components that operate at high electrical potentials helps to minimize electrical conduction through the cooling water, which causes losses, may result in electrolysis that could introduce oxygen and hydrogen into parts of the system, and otherwise interfere with system operations.

The deionized chill water system 804 may include a deionized water pressure tank 806. The deionized water pressure tank 806 may help maintain pressure in the deionized cooling loop, ensuring a consistent flow of cooling water to the ion source assembly 1000.

The cooling water system 800 may incorporate multiple flow control valves positioned throughout both cooling loops. In some cases, these valves may be used to regulate water flow to different components, allowing for precise temperature control across the isotope separation system.

The cooling water system 800 may also include pressure gauges and flow meters. In some embodiments, these instruments may be used to monitor the operation of the cooling system, providing data to the instrument & control system 500 for system management and safety provisions.

The cooling loops of the cooling water system 800 may be arranged in a closed-circuit configuration with return lines carrying heated water back to their respective cooling systems for recirculation. This closed-loop design may help maintain the purity of the deionized water and improve overall system efficiency.

The separation between the chill water system 802 and the deionized chill water system 804 may allow for electrical isolation of high-voltage components while maintaining effective cooling throughout the isotope separation system. The cooling water system 800 may be designed to handle a range of heat loads. In some embodiments, the system may be capable of managing heat loads between 500 watts and 2000 watts, with a nominal heat load of approximately 1200 watts. However, the specific heat load capacity may vary depending on the particular configuration and operating conditions of the isotope separation system.

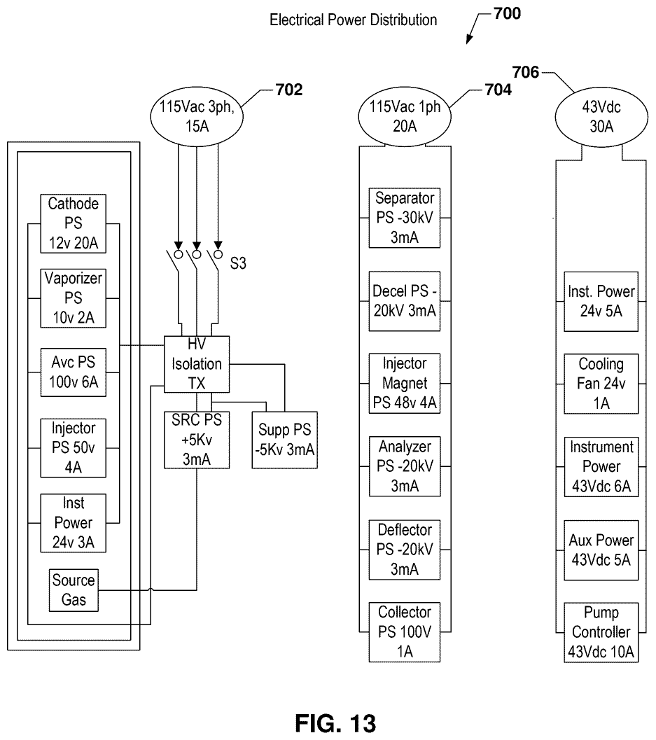

As the source module is anticipated to operate at approximately +10 kV, a high-voltage transformer appropriate to operate all sub-systems and instruments included in the source module is included in FIG. 13. However, some embodiments may not require such a transformer.

As with the power distribution diagram, the instrumentation and control diagram illustrated in FIG. 14 is provided here as an approximation of the final design. The exact control and signal scheme will be primarily driven by the exact needs of the various power supplies and instruments selected for use. The control scheme may be standardized, such as by incorporating the RS-485 communication protocol where possible in order to ensure high-fidelity, low-noise communication between all components. Similarly, interlock signaling will be specified to ensure an inherently safe, positive indication of both presence and status.

Various embodiments may include design features that provide for inherent passive safety. As some embodiments may be designed and assembled to operate within a shielded hotcell, the bulk of the radiation safety requirements may be imposed on the design of the hotcell. During various testing and experimental operations without radioactive materials, other non-radiation hazards may be present and may be controlled for in the design of the system. In some embodiments, the entire system may be enclosed or contained within a grounded, interlocked enclosure.

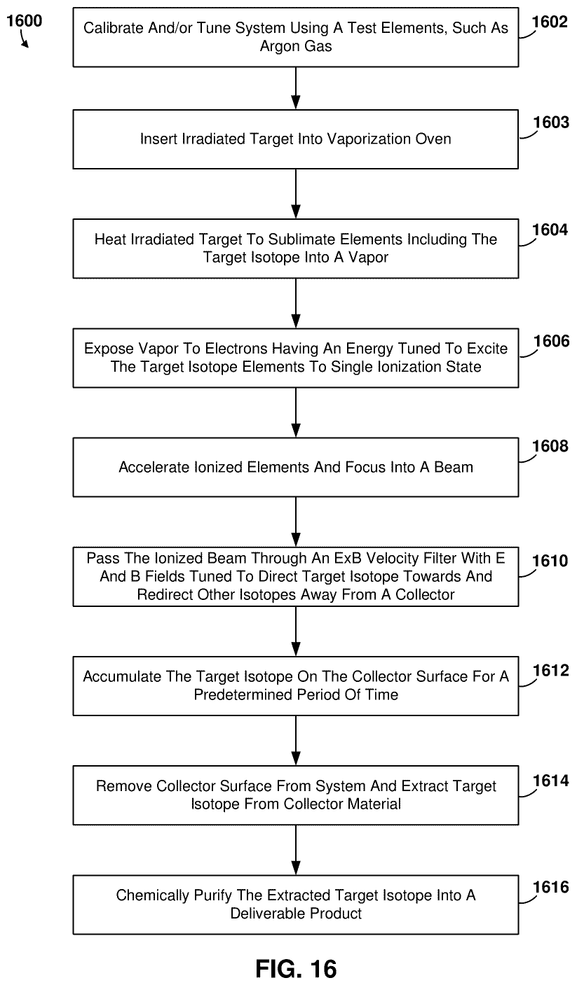

FIG. 16 illustrates an embodiment method of isotope separation using an isotope separation system 100 as described herein. The method 1600 may include several operations involved in processing and isolating target isotopes.

In operation 1602, the system may be calibrated and/or tuned using test elements, such as argon or xenon gas. This calibration process may involve adjusting various parameters of the system components, reviewing data from system instrumentation, and making adjustments to achieve acceptable system performance.

In operation 1603, an irradiated target may be inserted into the vaporization oven 2000. The irradiated target may contain the source material from which the target isotope will be separated.

In operation 1604, the irradiated target may be heated to sublimate elements, including the target isotope, into a vapor. The heating process may be controlled to achieve the desired vaporization or sublimation rate.

In operation 1606, the vapor may be exposed to electrons having an energy tuned to excite the target isotope elements to a single ionization state. In some cases, the voltages on a cathode chamber (e.g., 3000) and an anode may be set to provide a differential voltage that accelerates electrons to approximately 40 electron volts. This energy level may be optimal for single-ionization of certain isotopes while minimizing the production of double-ionized atoms.

In operation 1608, the ionized elements may be accelerated and focused into a beam. This process may involve the use of the injector assembly 4000 and its components, such as the accelerator cathode 4004, ground plate electrode 4006, and Einzel lens coaxial cylindrical electrodes 4008, 4010, 4012, as described above.

In operation 1610, the ionized beam may pass through a velocity filter 4106 in which the electric and magnetic fields are tuned to direct the target isotope towards and redirect other isotopes away from a selection collimator (e.g., 5106) or other selection mechanism that is part of a collector assembly (e.g., 5000). The velocity filter 4106 may be used for this separation process.

In some embodiments, the system may include a first turning magnet assembly to redirect the ion beam before entering the velocity filter. Additionally, the system may include a second turning magnet assembly to redirect the ion beam before entering the isotope collection module. These turning magnet assemblies may allow for a more compact system design or improved beam control.

In operation 1612, the target isotope may be accumulated on a collector surface (e.g., 5108) for a predetermined period of time.

In operation 1614, the collector surface may be removed from the system, such as by withdrawing the collector and its holder into a removal cask that is used to carry the radioactivity to a processing cell. There, the target isotope may be extracted from the collector material, such as by dissolving the isotope material in an acid.

In operation 1616, the extracted target isotope may be chemically purified into a deliverable product. This purification process may involve additional chemical treatments to ensure the final product meets the required purity standards, as well as preparing the final chemical form required for the final product or producing the final product.

In some embodiments, the first target isotope may be Lu-177, collected at a predetermined amount per day. In such applications, the isotope isolation system may operate at a beam current of approximately 12.7 microamps to produce 20-21 curies of Lu-177 within a 24-hour period. This specific operating condition may allow for consistent and controlled production of the target isotope at a commercially acceptable rate.

The method 1600 may be controlled and monitored by the instrument & control system 500, including one or more controller computing devices (e.g., 514, 518), which may adjust various parameters throughout the process to maintain optimal separation conditions. The vacuum and gas system 600, cooling water system 800, and power distribution system 700 may support the operation of the isotope separation system throughout the method 1600.

Implementation examples of various embodiments are described in the following paragraphs.

Example 1. A system for isotope separation, including: an ion source assembly configured to generate ions from a source material; an injector assembly positioned to receive from the ion source assembly and accelerate and focus the ions into a beam; a separator assembly positioned to receive ions from the injector assembly, the separator assembly including a velocity filter including: a magnet assembly configured to generate a magnetic field perpendicular to a beam path of the ions; and two electrodes positioned on either side of the beam path and configured to generate an electric field perpendicular to the beam path and the magnetic field, in which the electric field and the magnet field are controlled so that the beam path of the ions of a first target isotope is not deflected while ions of other isotopes or elements are deflected, and in which the two electrodes have curved portions that are sized and angled to vary the electric field to compensate for non-linearities in the magnetic field so that the ratio of the electric field strength to the magnetic field strength remains approximately constant within the volume of the velocity filter; a collimator coupled to a distal end of a drift path portion, the collimator including a first aperture, in which the drift path portion has a length sufficient to enable beams of different isotopes exiting the velocity filter to become spaced apart so that the beam of the first target isotope but not other isotopes passes through the first aperture; and an isotope collector module including a first removeable collection surface positioned beyond the collimator to collect atoms of the first target isotope.

Example 2. The system of example 1, in which the ion source assembly includes: a source oven configured to vaporize the source material; and a cathode assembly positioned to generate an electron beam directed toward the vaporized source material to ionize the source material in a reaction chamber.

Example 3. The system of example 2, in which the ion source assembly further includes a magnetic coil surrounding the source oven and cathode assembly to confine the electron beam.

Example 4. The system of any of examples 1-3, in which the injector assembly includes: an accelerator anode; a ground plate electrode; and an Einzel lens including three coaxial cylindrical electrodes.

Example 5. The system of any of examples 1-4, in which the isotope collector module further includes a vacuum isolation valve that enables the isotope collection module to be repressurized while the rest of the system remains in a vacuum, which enables the isotope collection target to be removed and replaced without shutting down the rest of the system.

Example 6. The system of any of examples 1-5, in which the collimator is positioned within a non-target isotope collection can so that the first target isotope ions pass through the collimator and non-target isotopes are retained in the non-target isotope collection can.

Example 7. The system of any of examples 1-6, in which the isotope collection module further includes a removable target positioning assembly including a shielded portion and a collection surface positioning mechanism, in which the removable target positioning assembly is configured to be inserted into a volume of the isotope collection module and the positioning mechanism extended to position the collection surface into position to receive the first target isotope during isotope collection operations, and to be removed from the isotope collection module after retracing the positioning mechanism to position the collection surface in the shielded portion to remove collected isotope material from the system.

Example 8. The system of any of examples 1-7, in which the isotope collection module further includes a decelerator portion including electrodes energized to generate an electric field with a polarity and field strength sufficient to decelerate isotope ions to thermal velocities before impacting the first collection surface.

Example 9. The system of any of examples 1-8, further including a vacuum system configured to maintain the ion source, injector, velocity filter, drift path portion, and isotope collection module under vacuum during operation.

Example 10. The system of any of examples 1-9, further including a cooling system providing deionized water to cool heated and heat-generating components of the system during operation.

Example 11. The system of any of examples 1-10, further including a power supply coupled to a control system configured to control power applied to magnets and voltages applied to electrodes of the ion source, injector, and velocity filter to provide collection of the target isotope at a predetermined rate of collection.

Example 12. The system of example 11, further including a current measuring sensor coupled to the first collection target and configured to provide to the control system measurements of total current accumulated on the first collection target over time, in which the control system is configured to use the measurements of total current accumulated on the first collection target to control voltages applied to electrodes of the injector, and velocity filter to collect the first target isotope at the predetermined rate of collection.

Example 13. The system of example 12, in which the first target isotope is Lu-177 and the rate of collection is a predetermined amount of Lu-177 per day.

Example 14. The system of example 7, in which: the system is configured to isolate a second target isotope; the collimator includes a second slit aperture spaced apart from the first aperture, in which the first aperture is positioned on the collimator to receive a beam of the first target isotope ions and the second aperture is positioned to receive a beam of the second target isotope ions; the isotope collector module further includes a second removable collection surface positioned to collect atoms of the second target isotope; and the target positioning mechanism of the removable target positioning assembly is configured to position both the first collection surface and second collection surface in the shielded portion and within the isotope collector module.

Example 15. The system of example 14, further including a deflector plate positioned adjacent to the collimator and configured to generate electric fields that further separate ion beams of the first and second isotopes prior to striking the first and second removable collection surfaces.

Example 16. The system of any of examples 1-15, in which the ion source, injector, velocity filter, drift path portion, and isotope collection module are positioned relative to one another in a linear configuration.

Example 17. The system of any of examples 1-16, further including a first turning magnet assembly positioned and configured to redirect a beam of ionized atoms exiting the injector through a non-zero angle αefore entering the velocity filter.

Example 18. The system of example 17, further including a second turning magnet assembly positioned and configured to redirect the beam of ionized atoms exiting the velocity filter through a non-zero angle before entering the isotope collection module.

Example 19. A method of separating isotopes, including: generating ions from a source material in an ion source assembly; accelerating and focusing the ions into a beam using an injector assembly and an Einzel lens; passing the ion beam through a velocity filter while controlling perpendicular electric and magnetic fields so that target isotope ions pass through without deflection and non-target isotope ions and element ions are deflected based on their respective velocities; separating the target isotope ions by passing those ions through a collimator positioned at a distal end of a drift path and configured so that non-target isotope ions and element ions are blocked; and collecting separated isotopes using an isotope collector assembly positioned beyond the collimator.

Example 20. The method of example 19, in which generating ions from the source material includes: vaporizing the source material in a source oven; and directing an electron beam produced in an accelerator cathode toward the vaporized source material to ionize the source material.

Example 21. A system for isotope separation, including: means for generating ions from a source material; means for accelerating and focusing the ions into a beam directed into a velocity filter; means for controlling perpendicular electric and magnetic fields in the velocity filter so that target isotope ions pass through without deflection and non-target isotope ions and element ions are deflected based on their respective velocities; means for separating the target isotope ions from non-target isotope and other element ions at a distal end of a drift path; and means for collecting the target isotope ions.

Further embodiments include a system for isotope separation that includes means for generating ions from a source material (e.g., ion source assembly 1000, source oven 2000, cathode assembly 3000), means for accelerating and focusing the ions into a beam (e.g., injector assembly 4000, accelerator cathode 4004, ground plate electrode 4006, Einzel lens coaxial cylindrical electrodes 4008, 4010, 4012), means for passing the ion beam through a velocity filter while controlling perpendicular electric and magnetic fields (e.g., separator assembly 4100, velocity filter 4106, magnet windings 4108, first electrode 4112, second electrode 4114), means for separating the target isotope ions (e.g., drift path 4900, target isotope slit collimator 5106), and means for collecting separated isotopes (e.g., isotope collector assembly 5000, target isotope collector 5020).

As used in this application, terminology such as “unit,” “component,” “module,” “system,” etc., is intended to encompass a software-implemented or computer-related entity. These entities may involve, among other possibilities, hardware, firmware, a blend of hardware and software, software alone, or software in an operational state. As examples, a component may encompass a running process on a processor, the processing system itself, an object, an executable file, a thread of execution, a program, or a computing device. To illustrate further, both an application operating on a computing device and the computing device itself may be designated as a component. A component might be situated within a single process or thread of execution or could be distributed across multiple processors or cores. In addition, these components may operate based on various non-volatile computer-readable media that store diverse instructions and/or data structures. Communication between components may take place through local or remote processes, function or procedure calls, electronic signaling, data packet exchanges, and memory interactions, among other known methods of network, computer, processor, or process-related communications.

A number of different types of memories and memory technologies are available or contemplated in the future, any or all of which may be included and used in systems and computing devices that implement the various embodiments.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

In one or more embodiments, the functions of the controller master and slave described herein may be implemented in hardware, software, firmware, or any combination thereof. If implemented in software, the functions may be stored as one or more instructions or code on a non-transitory computer-readable medium or non-transitory processor-readable medium. The operations of a method disclosed herein may be embodied in a processor-executable software module, which may reside on a non-transitory computer-readable or processor-readable storage medium.

In addition, the operations of a method may reside as one or any combination or set of codes and/or instructions on a non-transitory processor-readable medium and/or computer-readable medium, which may be incorporated into a computer program product. Emerging technologies, including quantum computing storage media and blockchain-based storage solutions, may further enhance data integrity and security. Artificial intelligence (AI) and machine learning (ML)-optimized hardware accelerators, such as graphical processing systems (GPUs) and tensor processing systems (TPUs), may be used to execute complex algorithms.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

We claim:

1. A system for isotope separation, comprising:
an ion source assembly configured to generate ions from a source material;
an injector assembly positioned to receive from the ion source assembly and accelerate and focus the ions into a beam;
a separator assembly positioned to receive ions from the injector assembly, the separator assembly comprising a velocity filter comprising:
a magnet assembly configured to generate a magnetic field perpendicular to a beam path of the ions; and
two electrodes positioned on either side of the beam path and configured to generate an electric field perpendicular to the beam path and the magnetic field,
wherein the electric field and the magnet field are controlled so that the beam path of the ions of a first target isotope is not deflected while ions of other isotopes or elements are deflected, and
wherein the two electrodes have curved portions that are sized and angled to vary the electric field to compensate for non-linearities in the magnetic field so that the ratio of the electric field strength to the magnetic field strength remains approximately constant within the volume of the velocity filter;
a collimator coupled to a distal end of a drift path portion, the collimator comprising a first aperture, wherein the drift path portion has a length sufficient to enable beams of different isotopes exiting the velocity filter to become spaced apart so that the beam of the first target isotope but not other isotopes passes through the first aperture; and
an isotope collector module comprising a first removeable collection surface positioned beyond the collimator to collect atoms of the first target isotope.

2. The system of claim 1, wherein the ion source assembly comprises:
a source oven configured to vaporize the source material; and
a cathode assembly positioned to generate an electron beam directed toward the vaporized source material to ionize the source material in a reaction chamber.

3. The system of claim 2, wherein the ion source assembly further comprises a magnetic coil surrounding the source oven and cathode assembly to confine the electron beam.

4. The system of claim 1, wherein the injector assembly comprises:
an accelerator anode;
a ground plate electrode; and
an Einzel lens comprising three coaxial cylindrical electrodes.

5. The system of claim 1, wherein the isotope collector module further comprises a vacuum isolation valve that enables the isotope collection module to be repressurized while the rest of the system remains in a vacuum, which enables the isotope collection target to be removed and replaced without shutting down the rest of the system.

6. The system of claim 1, wherein the collimator is positioned within a non-target isotope collection can so that the first target isotope ions pass through the collimator and non-target isotopes are retained in the non-target isotope collection can.

7. The system of claim 1, wherein the isotope collection module further comprises a removable target positioning assembly comprising a shielded portion and a collection surface positioning mechanism, wherein the removable target positioning assembly is configured to be inserted into a volume of the isotope collection module and the positioning mechanism extended to position the collection surface into position to receive the first target isotope during isotope collection operations, and to be removed from the isotope collection module after retracing the positioning mechanism to position the collection surface in the shielded portion to remove collected isotope material from the system.

8. The system of claim 1, wherein the isotope collection module further comprises a decelerator portion comprising electrodes energized to generate an electric field with a polarity and field strength sufficient to decelerate isotope ions to thermal velocities before impacting the first collection surface.

9. The system of claim 1, further comprising a vacuum system configured to maintain the ion source, injector, velocity filter, drift path portion, and isotope collection module under vacuum during operation.

10. The system of claim 1, further comprising a cooling system providing deionized water to cool heated and heat-generating components of the system during operation.

11. The system of claim 1, further comprising a power supply coupled to a control system configured to control power applied to magnets and voltages applied to electrodes of the ion source, injector, and velocity filter to provide collection of the target isotope at a predetermined rate of collection.

12. The system of claim 11, further comprising a current measuring sensor coupled to the first collection target and configured to provide to the control system measurements of total current accumulated on the first collection target over time, wherein the control system is configured to use the measurements of total current accumulated on the first collection target to control voltages applied to electrodes of the injector, and velocity filter to collect the first target isotope at the predetermined rate of collection.

13. The system of claim 12, wherein the first target isotope is Lu-177 and the rate of collection is a predetermined amount of Lu-177 per day.

14. The system of claim 7, wherein:
the system is configured to isolate a second target isotope;
the collimator comprises a second slit aperture spaced apart from the first aperture, wherein the first aperture is positioned on the collimator to receive a beam of the first target isotope ions and the second aperture is positioned to receive a beam of the second target isotope ions;
the isotope collector module further comprises a second removable collection surface positioned to collect atoms of the second target isotope; and
the target positioning mechanism of the removable target positioning assembly is configured to position both the first collection surface and second collection surface in the shielded portion and within the isotope collector module.

15. The system of claim 14, further comprising a deflector plate positioned adjacent to the collimator and configured to generate electric fields that further separate ion beams of the first and second isotopes prior to striking the first and second removable collection surfaces.

16. The system of claim 1, wherein the ion source, injector, velocity filter, drift path portion, and isotope collection module are positioned relative to one another in a linear configuration.

17. The system of claim 1, further comprising a first turning magnet assembly positioned and configured to redirect a beam of ionized atoms exiting the injector through a non-zero angle before entering the velocity filter.

18. The system of claim 17, further comprising a second turning magnet assembly positioned and configured to redirect the beam of ionized atoms exiting the velocity filter through a non-zero angle before entering the isotope collection module.

19. A method of separating isotopes, comprising:
generating ions from a source material in an ion source assembly;
accelerating and focusing the ions into a beam using an injector assembly and an Einzel lens;
passing the ion beam through a velocity filter while controlling perpendicular electric and magnetic fields so that target isotope ions pass through without deflection and non-target isotope ions and element ions are deflected based on their respective velocities;
separating the target isotope ions by passing those ions through a collimator positioned at a distal end of a drift path and configured so that non-target isotope ions and element ions are blocked; and
collecting separated isotopes using an isotope collector assembly positioned beyond the collimator.

20. The method of claim 19, wherein generating ions from the source material comprises:
vaporizing the source material in a source oven; and
directing an electron beam produced in an accelerator cathode toward the vaporized source material to ionize the source material.

21. A system for isotope separation, comprising:
means for generating ions from a source material;
means for accelerating and focusing the ions into a beam directed into a velocity filter;
means for controlling perpendicular electric and magnetic fields in the velocity filter so that target isotope ions pass through without deflection and non-target isotope ions and element ions are deflected based on their respective velocities;
means for separating the target isotope ions from non-target isotope and other element ions at a distal end of a drift path; and
means for collecting the target isotope ions.
